(19) United States
(12) Patent Application Publication
(10) Pub. No.: US 2026/0120412 A1
(43) Pub. Date: Apr. 30, 2026

(54) DYNAMIC REGION SIGNALING FOR EFFICIENT SPATIAL DATA TRANSMISSION

(71) Applicant: Nokia Technologies Oy, Espoo (FI)

(72) Inventors: Serhan GÜL, Munich (DE); Saba AHSAN, Espoo (FI); Igor Danilo Diego CURCIO, Vimercate (IT); Patrice RONDAO ALFACE, Antwerp (BE); Emre Baris AKSU, Tampere (FI)

(21) Appl. No.: 19/365,462

(22) Filed: Oct. 22, 2025

Related U.S. Application Data
(60) Provisional application No. 63/711,631, filed on Oct. 24, 2024.

(51) Int. Cl. G06T 19/00; H04L 67/131

(52) U.S. Cl. CPC G06T 19/00; H04L 67/131; G06T 2210/36; G06T 2219/024

(57) ABSTRACT

An apparatus configured to: transmit, to a server apparatus, a request for spatial data, wherein the request for the spatial data comprises, at least, at least one spatial signal indicating at least one spatial region of interest associated with an environment; and receive, from the server apparatus, the spatial data for the at least one spatial region of interest. An apparatus configured to: receive, from a client apparatus, a request for spatial data, wherein the request for the spatial data comprises, at least, at least one spatial signal indicating at least one spatial region of interest associated with an environment; obtain the spatial data based, at least partially, on the request; and transmit, to the client apparatus, the spatial data.

### TECHNICAL FIELD

The example and non-limiting embodiments relate generally to extended reality applications and, more particularly, to provision of spatial data.

### BACKGROUND

It is known, in extended reality applications, to provide a dense spatial map representation of an environment.

### SUMMARY

The following summary is merely intended to be illustrative. The summary is not intended to limit the scope of the claims.

In accordance with one aspect, an apparatus comprising: at least one processor; and at least one memory storing instructions that, when executed with the at least one processor, cause the apparatus at least to: transmit, to a server apparatus, a request for spatial data, wherein the request for the spatial data comprises, at least, at least one spatial signal indicating at least one spatial region of interest associated with an environment; and receive, from the server apparatus, the spatial data for the at least one spatial region of interest.

In accordance with one aspect, a method comprising: transmitting, with a client apparatus to a server apparatus, a request for spatial data, wherein the request for the spatial data comprises, at least, at least one spatial signal indicating at least one spatial region of interest associated with an environment; and receiving, from the server apparatus, the spatial data for the at least one spatial region of interest.

In accordance with one aspect, an apparatus comprising means for: transmitting, to a server apparatus, a request for spatial data, wherein the request for the spatial data comprises, at least, at least one spatial signal indicating at least one spatial region of interest associated with an environment; and receiving, from the server apparatus, the spatial data for the at least one spatial region of interest.

In accordance with one aspect, a non-transitory computer-readable medium comprising program instructions stored thereon for performing at least the following: causing transmitting, with a client apparatus to a server apparatus, of a request for spatial data, wherein the request for the spatial data comprises, at least, at least one spatial signal indicating at least one spatial region of interest associated with an environment; and causing receiving, from the server apparatus, of the spatial data for the at least one spatial region of interest.

In accordance with one aspect, an apparatus comprising: at least one processor; and at least one memory storing instructions that, when executed with the at least one processor, cause the apparatus at least to: receive, from a client apparatus, a request for spatial data, wherein the request for the spatial data comprises, at least, at least one spatial signal indicating at least one spatial region of interest associated with an environment; obtain the spatial data based, at least partially, on the request; and transmit, to the client apparatus, the spatial data.

In accordance with one aspect, a method comprising: receiving, with a server apparatus from a client apparatus, a request for spatial data, wherein the request for the spatial data comprises, at least, at least one spatial signal indicating at least one spatial region of interest associated with an environment; obtaining the spatial data based, at least partially, on the request; and transmitting, to the client apparatus, the spatial data.

In accordance with one aspect, an apparatus comprising means for: receiving, from a client apparatus, a request for spatial data, wherein the request for the spatial data comprises, at least, at least one spatial signal indicating at least one spatial region of interest associated with an environment; obtaining the spatial data based, at least partially, on the request; and transmitting, to the client apparatus, the spatial data.

In accordance with one aspect, a non-transitory computer-readable medium comprising program instructions stored thereon for performing at least the following: causing receiving, with a server apparatus from a client apparatus, of a request for spatial data, wherein the request for the spatial data comprises, at least, at least one spatial signal indicating at least one spatial region of interest associated with an environment; causing obtaining the spatial data based, of at least partially, on the request; and causing transmitting, to the client apparatus, of the spatial data.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3 is a flowchart illustrating steps as described herein;

FIG. 4 is a flowchart illustrating steps as described herein;

FIG. 5 is a flowchart illustrating steps as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein;

FIG. 11 is a diagram illustrating features as described herein;

FIG. 12 is a diagram illustrating features as described herein;

FIG. 13 is a diagram illustrating features as described herein;

FIG. 14 is a diagram illustrating features as described herein;

FIG. 15 is a flowchart illustrating steps as described herein; and

FIG. 16 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
5GMS 5G media streaming
AF application function
AI artificial intelligence
AR augmented reality
AS application server
AVP audio/video profile
CDMA code division multiple access
CPU central processing unit
CRAN cloud radio access network
eNB (or eNodeB) evolved Node B (e.g., an LTE base station)
DC data channel
DCAS data channel application server
DCSF data channel signaling function
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HMD head-mounted display
HTTP hypertext transfer protocol
IEEE Institute of Electrical and Electronics Engineers
IMD integrated messaging device
IMS instant messaging service
IMS internet protocol multimedia subsystem
IoT Internet of Things
IP internet protocol
JSON JavaScript Object Notation
LoD Level of Detail
LTE long term evolution
MAF media access function
MF (IMS) media function
ML machine learning
MMS multimedia messaging service
MPEG-I Moving Picture Experts Group immersive codec family
MR mixed reality
MRF mixed reality function
MSRP message session relay protocol
MTSI multimedia telephone service for internet protocol multimedia subsystem
ng or NG new generation
ng-eNB or NG-eNB new generation eNB
NR new radio
N/W or NW network
O-RAN open radio access network
PC personal computer
PDA personal digital assistant
QoS quality of service
ROI region of interest
RTC real time communication
RTCP real time transport control protocol
RTP real time transport protocol
SCC spatial computing client
SCS spatial computing server
SCTP stream control transmission protocol
SDP session description protocol
SIP session initiation protocol
SLAM simultaneous localization and mapping
SMS short messaging service
TCP transmission control protocol
TCP-IP transmission control protocol-internet protocol
TDMA time division multiple access
UDP user datagram protocol
UE user equipment (e.g., a wireless, typically mobile device)
UMTS universal mobile telecommunications system
USB universal serial bus
VNR virtualized network function
VR virtual reality
WebRTC web real-time communication
WLAN wireless local area network
XR extended reality

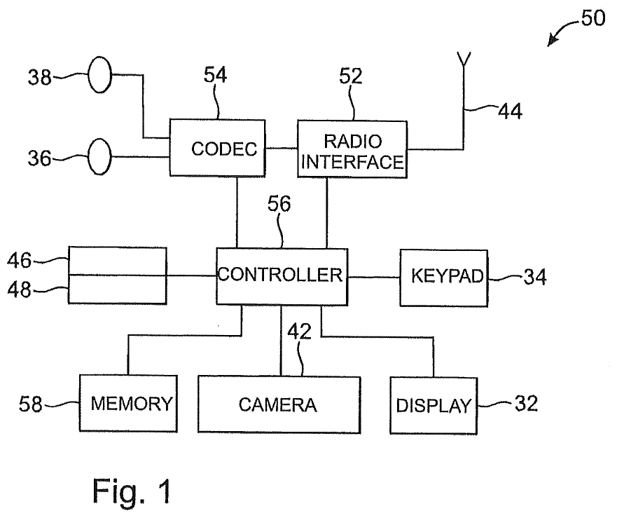

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments of the present disclosure may be any one of: an earpiece, speaker, or an analogue audio or digital audio output connection. The electronic device 50 may also comprise a battery (or in other example embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments of the present disclosure the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

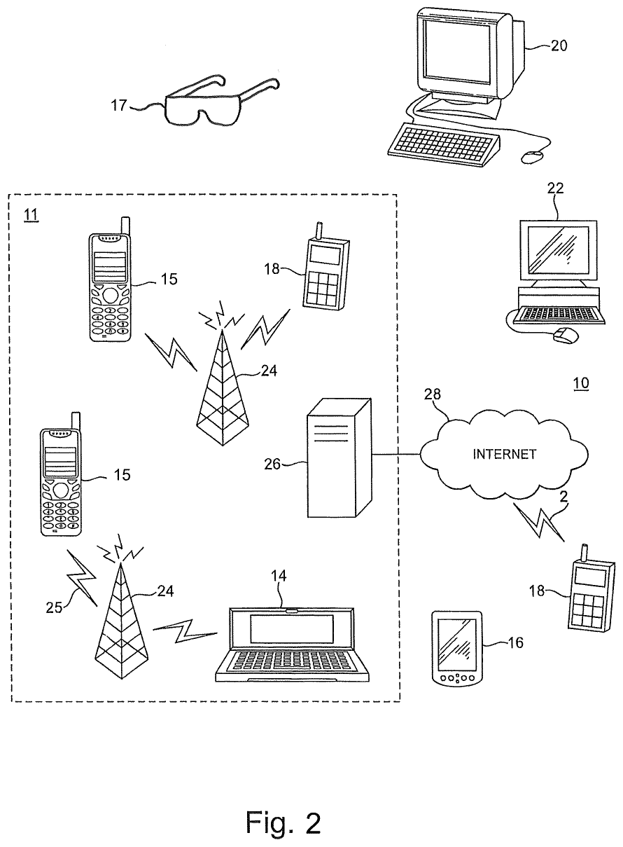

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments of the present disclosure.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments of the present disclosure may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments of the present disclosure may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IoT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Features as described herein may generally relate to spatial computing. Spatial computing is a general term that refers to the use of digital technology to understand and interact with the physical world in three dimensions. This emerging field encompasses various technologies and techniques that enable devices to perceive and interact with their surroundings in a more natural and intuitive manner.

One of the key components of spatial computing is spatial mapping and localization. This process involves creating a map of an environment and establishing the position of users and objects (both real and virtual) within that environment. The environment may be a real-world environment in which AR/XR/MR applications may be used/consumed. The map of the real-world environment may be a spatial map. By doing so, spatial computing systems can provide a seamless integration between the digital and physical worlds, enabling more immersive and context-aware experiences.

To achieve persistent placement and tracking of virtual objects in real-world environments, spatial computing systems utilize spatial anchors. These are virtual reference points that allow extended reality (XR) devices to accurately position and maintain the location of digital content relative to the physical space. Spatial anchors play a crucial role in creating stable and consistent augmented reality experiences.

XR relates to a variety of immersive technologies, including but not limited to virtual reality (VR), augmented reality (AR), and mixed reality (MR). Virtual reality (VR) is an area of technology in which video content may be provided (e.g. streamed) to, for example, a VR display system. VR video content may be provided alongside other VR content, such as audio, haptic, etc. content. The VR display system may be provided with a live or stored feed from a video content source, the feed representing a VR space or world for immersive output through the display system. A virtual space or virtual world is any computer-generated version of a space, for example a captured real-world space, in which a user can be immersed through a display system such as a VR headset. A VR headset may be configured to provide VR video and audio content to the user, e.g. through the use of a pair of video screens and headphones incorporated within, or associated with, the headset. A VR headset may be configured to provide feedback, for example pose/haptic data, to a server for purposes of informing the provision of VR content. Augmented reality (AR) and mixed reality (MR) may be similar to VR in that video content may be provided, as above, which may be overlaid over or combined with aspects of a real-world environment in which the AR/MR content is being consumed. A user of AR content may therefore experience a version of the real-world environment that is “augmented” with additional virtual features, such as virtual visual and/or audio objects. A device may provide AR video and audio content overlaid over a visible, see-through, or recorded version of the real-world visual and audio elements. In summary, XR is the overarching category that includes VR, AR, and MR, each offering different levels and types of interaction between the real and virtual worlds.

XR runtimes typically employ simultaneous localization and mapping (SLAM) algorithms for mapping previously unknown environments while simultaneously localizing the user or device within that environment. SLAM is a fundamental technology in spatial computing, enabling devices to build a map of their surroundings in real-time while keeping track of their own position within that map.

There are various SLAM algorithms available, each with its own approach to processing environmental data. Some rely solely on RGB data from cameras, while others utilize RGB-D (RGB plus depth) information. More advanced algorithms, known as visual-inertial SLAM, incorporate data from inertial sensors in addition to visual information, providing more robust and accurate spatial mapping and localization.

Spatial mapping and localization can be performed either on the device itself, or with support from network elements. On-device processing may offer the advantage of lower latency and independence from network connectivity, while network-supported solutions may leverage more powerful computing resources and potentially provide more accurate and up-to-date environmental data.

Features described herein may generally relate to network-assisted spatial computing. Splitting spatial mapping and localization between the network and XR device may offer several technical effects. This approach may allow for more efficient and scalable management of spatial data, enabling enhanced user experiences and collaborative environments.

One key advantage may be that the network can store the spatial map data for a specific environment, which may make it accessible to multiple XR devices. This centralized storage may enable large-scale spatial maps to be handled by the network, which would not be possible for individual devices to manage on their own. Additionally, the network can store the data persistently, which may allow users to find virtual objects previously placed at a location, thereby enhancing the continuity of the XR experience.

Another significant benefit may be the ability for multiple users to access and contribute to the same spatial map. This feature may enable collaborative and shared virtual environments, which may open up new possibilities for interactive and immersive experiences across various applications.

From a device perspective, the XR hardware may benefit from reduced processing load, as the network may handle much of the spatial computing tasks. This may free up resources on the device for other tasks such as rendering, potentially improving overall performance. Furthermore, the reduced computational burden on the XR device leads to lower power consumption, extending battery life and enhancing the user experience.

3GPP SA4 has explored some split spatial computing use cases. TR 26.928 contains some relevant use cases, including: real-time sharing of XR content, XR multimedia streaming, and XR conference. The common element of these XR use cases is the use of a spatial computing server (SCS) that provides spatial maps, spatial anchors and localization services to the devices.

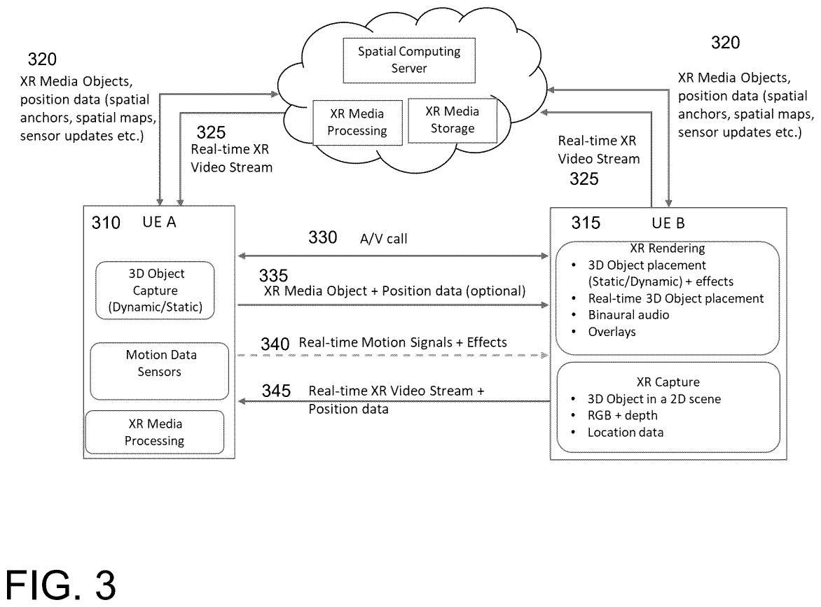

Referring now to FIG. 3, illustrated is an example of real-time sharing of XR content. In the example of FIG. 3, the network (305) may comprise a spatial computing server, an XR media processing module, and a XR media storage module. The NW (305) may provide XR media objects, position data (spatial anchors, spatial maps, sensor updates, etc.) (320) and real-time XR video streams (325) to multiple UEs, for example UE A (310) and UE B (315). The UEs (310, 315) may also provide XR media objects, position data (spatial anchors, spatial maps, sensor updates, etc.) (320) to the NW (305). In the example of FIG. 3, the UE A (310) may comprise a capability for 3D object capture (dynamic/static), motion data sensors, and/or a capability for XR media processing. In the example of FIG. 3, the UE B (315) may comprise a capability for XR rendering (e.g. 3D object placement (static/dynamic) plus effects, real-time RD object placement, binaural audio, overlays, etc.) and/or a capability for XR capture (e.g. 3D object in a 2D scene, RGB+depth, location data, etc.).

In the example of FIG. 3, the UE A (310) and the UE B (315) may initiate an A/V call (330). At 335, the UE A (310) may transmit, to the UE B (315), XR media object and, optionally, position data. At 340, the UE A (310) may, optionally, transmit to the UE B (315) real-time motion signals and effects. At 345, the UE B (315) may transmit, to UE A (310), real-time XR video stream and position data.

TR 26.998 describes the envisaged downlink and uplink procedures in an spatial computing session.

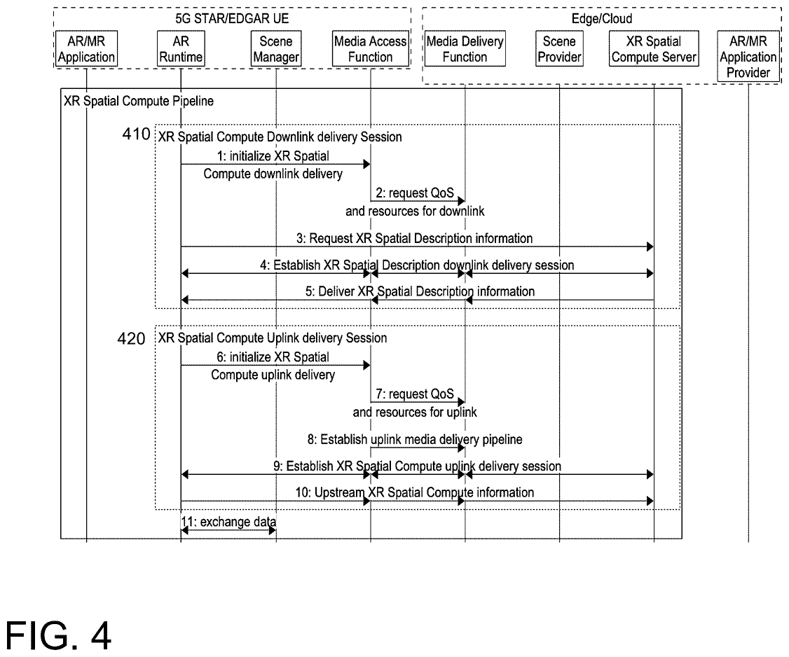

Referring now to FIG. 4, from TR 26.998, illustrated are examples of XR spatial computing procedures for the downlink (410) and uplink (420) cases.

In the case of XR spatial compute downlink delivery session (410), the following may be performed:
“ . . . For a XR Spatial Compute downlink delivery session:
1. The XR Spatial Compute function in the AR Runtime asks the MAF to establish a XR Spatial Compute downlink delivery session
2. The MAF communicates with the network to establish the proper resources and QoS
3. The XR Spatial Compute function requests access to XR Spatial Description information
4. An XR Spatial Description downlink delivery session is established across the XR Spatial Compute server, the media delivery function, the media access function and XR Spatial Compute function on the device.
5. XR Spatial Description information is delivered in this downlink delivery session . . . ”

In the case of XR spatial compute uplink delivery session (420), the following may be performed:
“ . . . For a XR Spatial Compute uplink delivery session:
6. The XR Spatial Compute function in the AR Runtime asks the MAF to establish a XR Spatial Compute uplink delivery session
7. The MAF communicates with the network to establish the proper resources and QoS
8. The MAF established an appropriate uplink delivery pipeline
9. An XR Spatial Description uplink delivery session is established across the XR Spatial Compute function on the device, the media access function, the media delivery function and the XR Spatial Compute server.
10. Spatial compute information is upstreamed to the XR Spatial Compute server.
11. Data is continuously exchanged between the Scene Manager and the AR Runtime . . . ”

3GPP SA4 also did initial normative work on spatial descriptions for IMS-based AR real-time communication in TS 26.264 [v18.0.0]:
“ . . . 6.3.1 Spatial Description Format
6.3.1.1 General
A spatial description format is used for defining the physical space around a UE or trackable in which virtual content can be inserted. This clause includes the supported formats and the method for exchanging the information between AR-MTSI clients.
6.3.1.2 Available Visualization Space
An AR-MTSI client in terminal may send available visualization space, user position and other trackable poses to AR MF/MRF for scene creation and update.
The available visualization space defines an occlusion-free space around the user for rendering the AR scene as a geometric primitive. The format for available visualization space is defined in clause 12.4 of [3]. The type of the message containing visualization space as a payload shall be “urn:3gpp:ar:v1:visualization-space”. The available VisualizationSpace object [3] shall contain a xrSpaceId. The xrSpaceId is used for determining the local coordinate axis of the visualization space. The xrSpaceId shall be a unique identifier for an XR space of one AR-MTSI client in terminal. If the visualization space is sent, then initial user pose shall be sent. The user pose and visualization space are in reference to the same xrSpaceId.
If the visualization space is anchored to another trackable (instead of the user) not anchored around the user or if the viewer is not the centre of the visualization space, an initial pose for a trackable as defined in clause 6.3.1.3 may be used.
6.3.1.3 Initial Pose
Trackable is a real-world object (e.g., the UE, floor, controllers, table etc.) that the UE can detect, which can be used as a reference to anchor virtual objects to the real world.
The AR-MTSI client in terminal that sends the available visualization space may also send at least one pose for a trackable within the visualization space. The AR-MTSI client in terminal may send additional poses for anchoring virtual objects. The poses shall be sent using the format defined in clause 6.2.2 of [3]. The poseInfo (as defined in Table 6.2.2-1 [3]) shall contain an xrSpaceId that is the same as the one used for visualization space. The poses may additionally contain a label string to identify the type of anchor. The labels are application-dependent, but for example, user, floor, left controller etc., can be used as labels. The type of the message for a pose sent for scene creation shall be set to “urn:3gpp:ar:v1:initial-pose” . . . ”

Pose format is defined in TS 26.119 [v18.0.0] as follows, and with respect to TABLE 1, which shows pose formats:
12.2 Pose format
The Pose format is used to share pose information, e.g. about predicted poses with the network.
Each predicted pose shall contain the associated predicted display time and an identifier of the XR space that was used for that pose.
Depending on the view configuration of the XR session, there could be different pose information for each view.
The payload of the message shall follow the structure defined in Table 12.2-1 . . . ”

TABLE 1

| Name | Type | Cardinality | Description |
|---|---|---|---|
| poseInfo | Object | 1 . . . n | An array of pose information objects, |
| | | | each corresponding to a target display |
| | | | time and XR space. |
| poseTime | number | 1 . . . 1 | The time for which the current poses |
| | | | are predicted. This time is expressed in |
| | | | XR system time clock. |
| xrSpaceId | number | 0 . . . 1 | An identifier for the XR space in which |
| | | | the poses are expressed. |
| poses | Object | 1 . . . n | An array that provides a list of the |
| | | | poses. |
| | | | For view poses, the first pose |
| | | | corresponds to the left view and the |
| | | | second to the right view. |
| trackableSpaceId | number | 0 . . . 1 | A unique identifier of the XR space of |
| | | | the trackable that was agreed upon |
| | | | during session setup. The pose |
| | | | corresponds to the origin of that |
| | | | trackableSpaceId expressed in the XR |
| | | | space identified by xrSpaceId. |
| | | | This is only applicable for trackable |
| | | | pose. |
| orientation | Object | 1 . . . 1 | Represents the orientation of the pose |
| | | | as a quaternion based on the reference |
| | | | XR space identified by xrSpaceId. |
| x | number | 1 . . . 1 | Provides the x coordinate of the |
| | | | quaternion. |
| y | number | 1 . . . 1 | Provides the y coordinate of the |
| | | | quaternion. |
| z | number | 1 . . . 1 | Provides the z coordinate of the |
| | | | quaternion. |
| w | number | 1 . . . 1 | Provides the w coordinate of the |
| | | | quaternion. |
| position | Object | 0 . . . 1 | Represents the position of the pose |
| | | | relative to the XR space identified by |
| | | | xrSpaceId. |
| x | number | 1 . . . 1 | Provides the x coordinate of the |
| | | | position vector. |
| y | number | 1 . . . 1 | Provides the y coordinate of the |
| | | | position vector. |
| z | number | 1 . . . 1 | Provides the z coordinate of the |
| | | | position vector. |
| confidence | number | 0 . . . 1 | Provides a confidence score that |
| | | | reflects the probability for this pose |
| | | | prediction to be correct. For the current |
| | | | pose or a pose in the past, the |
| | | | confidence value would be 1. The |
| | | | confidence can take a value between 0 |
| | | | and 1. |
| estimatedAtTime | number | 0 . . . 1 | The wall clock time when the pose |
| | | | estimation was made. (ref. T1) |
| fov | Object | 0 . . . 1 | Indicates the four sides of the field of |
| | | | view used for the projection of the |
| | | | corresponding XR view. |
| | | | This field is only present if these field |
| | | | of view values have changed from the |
| | | | last sent values. |
| | | | This is only applicable for view poses |
| angleLeft | number | 1 . . . 1 | The angle in radians of the left side of |
| | | | the field of view. For a symmetric field |
| | | | of view this value is negative. |
| angleRight | number | 1 . . . 1 | The angle in radians of the right side of |
| | | | the field of view. |
| angleUp | number | 1 . . . 1 | The angle in radians of the top part of |
| | | | the field of view. |
| angleDown | number | 1 . . . 1 | The angle in radians of the bottom part |
| | | | of the field of view. For a symmetric |
| | | | field of view this value is negative. |

Available visualization space is defined in TS 26.119 [v18.0.0] as follows, and with respect to TABLE 2, which shows available visualization space:
“ . . . 12.4 Available Visualization Space format
The XR Application may define a three-dimensional space within the user's real-word space that is suitable for rendering virtual objects called the Available Visualization Space. Such a space is defined with a shape which is either cube or sphere with the corresponding size and coordinates. In the case that the virtual scene is rendered by a remote entity (e.g. split rendering), this Available Visualization Space may be transmitted to this remote entity so that the composed AR objects remain within the defined Available Visualization Space. The method of calculating the Available Visualization Space is out of the scope of this document.
The content of the available VisualizationSpace type shall follow the format defined in Table 12.4-1 . . . ”

TABLE 2

| Name | Type | Cardinality | Description |
|---|---|---|---|
| availableVisualizationSpace | Object | 0 . . . 1 | An object defining the coordinate of |
| | | | the available visualization space. |
| xrSpaceId | number | 0 . . . 1 | An identifier for the XR space in |
| | | | which the available visualization |
| | | | space is expressed. |
| cuboid | Object | 0 . . . 1* | The available visualization space in |
| | | | form of cuboid. The 3D coordinates |
| | | | are expressed in the XR Space |
| | | | identified by xrSpaceId. |
| x | float | 1 | Offset of the available visualization |
| | | | space starting point in the x |
| | | | direction. |
| | | | The value is in meters. |
| y | float | 1 | Offset of the available visualization |
| | | | space starting point in the y |
| | | | direction as defined by the Open |
| | | | XR coordinate system. |
| | | | The value is in meters. |
| z | float | 1 | Offset of the available visualization |
| | | | space starting point in the z |
| | | | direction. |
| | | | The value is in meters. |
| width | float | 1 | The width of available visualization |
| | | | space in the x direction as defined |
| | | | by the Open XR coordinate system. |
| | | | The value is in meters. |
| height | float | 1 | The height of available visualization |
| | | | space in the y direction. |
| | | | The value is in meters. |
| depth | float | 1 | The depth of available visualization |
| | | | space in the z direction. |
| | | | The value is in meters. |
| sphere | Object | 0 . . . 1* | The available visualization space in |
| | | | form of a sphere. The 3D |
| | | | coordinates are expressed in the XR |
| | | | Space identified by xrSpaceId |
| x | float | 1 | Offset of the available visualization |
| | | | space center in the x direction as |
| | | | defined by the Open XR coordinate |
| | | | system. |
| | | | The value is in meters. |
| y | float | 1 | Offset of the available visualization |
| | | | space center in the y direction. |
| | | | The value is in meters. |
| z | float | 1 | Offset of the available visualization |
| | | | space center in the z direction. |
| | | | The value is in meters. |
| radius | float | 1 | The radius of available visualization |
| | | | space. |
| | | | The value is in meters. |

*Only one of cuboid or sphere object shall exists.

Available visualization space is further defined as follows:
“ . . . With this Available Visualization Space, a user may for instance avoid the virtual objects to be occluding other real objects in the scene, e.g. TV sets, people, etc., since an AR experience is achieved by the integration of visual objects into the user environment.”

TS 26.119 also defines the following terms:
“ . . . XR Space: a frame of reference in which 3D coordinates are expressed.
Trackable: a real-world object that can be tracked by the XR runtime. Each trackable provides a local reference space, also known as a trackable space, in which an anchor can be expressed . . . ”

3GPP SA1 considered some spatial computing use cases in the Release 19 study on Localized Mobile Metaverse Services, documented in TR 22.856 [v19.2.0].

The localized mobile metaverse service enabler, as described in clause 5.1, explores the potential service opportunities that arise when advanced location information is available to trigger AR-based services. This use case demonstrates how contextual awareness can enhance user experiences in the metaverse. For example, AR glasses could display recommended restaurants when a user is seeking a place to eat, providing timely and relevant information based on the user's location and preferences.

The spatial anchor enabler, described in clause 5.4, focuses on creating and sharing AR content within the metaverse. This enabler introduces two key roles: the ‘spatial anchor producer’ and the ‘spatial anchor consumer’. The producer determines what content to share, its location, and any associated constraints or additional information. This could include specifying who can access the spatial anchor and what resources are linked to it, such as AR media or mobile metaverse services. On the other hand, the ‘spatial anchor consumer’ can recognize anchors associated with specific locations and use them to obtain the linked information, enabling a more interactive and content-rich metaverse experience.

Clause 5.5 introduces the spatial mapping and localization service enabler, which addresses the creation and utilization of spatial maps as service enablers. This use case is divided into two main components: the Spatial Mapping Service and the Spatial Localization Service. The Spatial Mapping Service focuses on creating and maintaining accurate spatial maps of the environment. In contrast, the Spatial Localization Service employs these maps to identify the customer's precise location within the mapped space. Together, these services provide a foundation for more accurate and context-aware AR experiences in the metaverse, enabling users to interact with virtual content that is seamlessly integrated with their physical surroundings.

Features as described herein may generally relate to the session description protocol (SDP). SDP is a format for describing multimedia communication sessions for the purpose of announcement and negotiation. Its predominant use is in support of streaming media applications. SDP does not deliver any media streams itself, but is used between endpoints for negotiation of network metrics, media types, bandwidth requirements and other associated properties. The set of properties and parameters is called a session profile. SDP is extensible for the support of new media types and formats. SDP is widely deployed in the industry and is used for session initialization by various other protocols, such as session initiation protocol (SIP) or web real-time communication (WebRTC) related session negotiation.

SDP describes a session as a group of fields in a text-based format, with one field per line. The form of each field is as follows:
<character>=<value><CR><LF>

Where <character> is a single case-sensitive character and <value> is structured text in a format that depends on the character. Values are typically UTF-8 encoded. Whitespace is not allowed immediately to either side of the equal sign.

Session descriptions consist of three sections: session, timing, and media descriptions. Each description may contain multiple timing and media descriptions. Names are only unique within the associated syntactic construct.

Fields must appear in the order shown; optional fields are marked with an asterisk:
v=(protocol version number, currently only 0)
o=(originator and session identifier: username, id, version number, network address)
S=(session name: mandatory with at least one UTF-8-encoded character)
i=* (session title or short information)
u=* (URI of description)
e=* (zero or more email address with optional name of contacts)
p=* (zero or more phone number with optional name of contacts)
c=* (connection information—not required if included in all media)
b=* (zero or more bandwidth information lines)

One or more time descriptions (“t=” and “r=” lines; see below) may be used:
z=* (time zone adjustments)
k=* (encryption key)
a=* (zero or more session attribute lines)

Zero or more Media descriptions (each one starting by an “m=” line; see below) may be used, for example time description (mandatory):
t=(time the session is active)
r=* (zero or more repeat times)

and/or media description:
m=(media name and transport address)
i=* (media title or information field)
c=* (connection information-optional if included at session level)
b=* (zero or more bandwidth information lines)
k=* (encryption key)
a=* (zero or more media attribute lines-overriding the Session attribute lines)

Below is a sample session description from RFC 8866. This session is originated by the user “jdoe”, at IPv4 address 198.51.100.1. Its name is “Call to John Smith” and session information (“SDP Offer #1”) is included along with a link for additional information and an email address and phone number to contact the responsible party, Jane Doe:

v=0
o=jdoe 3724394400 3724394405 IN IP4 198.51.100.1
s=Call to John Smith
i=SDP Offer #1
u=http://www.jdoe.example.com/home.html
e=Jane Doe <jane@jdoe.example.com>
p=+1 617 555-6011
c=IN IP4 198.51.100.1
t=0 0
m=audio 49170 RTP/AVP 0
m=audio 49180 RTP/AVP 0
m=video 51372 RTP/AVP 99
c=IN IP6 2001:db8::2
a=rtpmap:99 h263-1998/90000

In the example above, the timing information indicates that the session duration in unspecified. Three media descriptions are provided, all using the real time transport protocol (RTP) Audio/Video Profile (AVP). The first is an audio stream on port 49170 using the payload type 0 (defined by RFC 3551 as PCMU), the second is another audio stream on port 49180 using again the payload type 0, the third is a video stream on port 51372 using the payload type 99 (defined as “dynamic”). Finally, an attribute is included which maps the payload type 99 to format h263-1998 with a 90 kHz clock rate. RTCP ports of 49171, 49181, 51373 are implied by the defined ports for the media streams.

SDP uses attributes to extend the core protocol. Attributes can appear within the Session or Media sections and are scoped accordingly as session-level or media-level. New attributes can be added to the standard through registration with IANA.

A media description may contain any number of “a=” lines (attribute-fields) that are media description specific. Session-level attributes convey additional information that applies to the session as a whole rather than to individual media descriptions.

Attributes are either properties or values, for example:

a=<attribute-name>
a=<attribute-name>:<attribute-value>

Examples of attributes defined in RFC8866 are “rtpmap” and “fmtp”. The “rtpmap” attribute maps from an RTP payload type number (as used in an “m=” line) to an encoding name denoting the payload format to be used. It also provides information on the clock rate and encoding parameters. Up to one “a=rtpmap:” attribute can be defined for each media format specified. Thus, we might have the following:

m=audio 49230 RTP/AVP 96 97 98
a=rtpmap:96 L8/8000
a=rtpmap:97 L16/8000
a=rtpmap:98 L16/11025/2

In the example above, the media types are “audio/L8” and “audio/L16”.

Parameters added to an “a=rtpmap:” attribute should only be those required for a session directory to make the choice of appropriate media to participate in a session. Codec-specific parameters should be added in other attributes, for example, “fmtp”. The “fmtp” attribute allows parameters that are specific to a particular format to be conveyed in a way that SDP does not have to understand them. The format must be one of the formats specified for the media. Format-specific parameters, semicolon separated, may be any set of parameters required to be conveyed by SDP and given unchanged to the media tool that will use this format. At most one instance of this attribute is allowed for each format. An example is:

$$a = fmtp : 96 profile - level - id = 42 e 016 ; \\ max - mbps = 108000 ; max - fs = 3600$$

Features as described herein may generally relate to WebRTC data channels. In WebRTC, a data channel is a bi-directional communication pathway that allows for the transmission of arbitrary data between peers. It is designed to enable peer-to-peer data exchange in real-time, complementing the audio and video capabilities of WebRTC. Designed for real-time applications, data channels provide low-latency communication, making them suitable for interactive applications such as gaming, file transfer, chat, etc. Data channels can operate in either reliable or unreliable modes. The reliable mode ensures that data is delivered in order and without loss, similar to TCP. The unreliable mode allows for out-of-order delivery and potential data loss, similar to user datagram protocol (UDP), which can be useful for applications where speed is more critical than reliability.

The subprotocol is signaled as part of the SDP [RFC 8866] exchange during the WebRTC connection setup using the “a=dcmap:” attribute line [RFC 8864]. When a data channel is created, its configuration, including the subprotocol, is included in the SDP offer/answer exchanged between the peers. This ensures that both peers are aware of the subprotocol and can agree on how to handle the data transmitted over the data channel.

In the SDP media description, each data channel declaration may also be followed by other SDP attributes, which apply to the corresponding data channel and its subprotocol. Each of these attributes is represented by one new “a=dcsa:” attribute line that references another SDP attribute defined for use with this data channel's subprotocol. An example is given below:

$$a = dcmap : 2 subprotocol = {}^{‶} {msrp}^{″} ; ordered = true ; label = {}^{‶} {msrp}^{″}$$

$$a = dcsa : 2 accept - types : text / plain$$

In the example, the “a: dcmap:” line specifies that the message session relay protocol (MSRP) subprotocol is exchanged via the data channel and the receiver will dispatch DATA chunks in the data channel to the upper layer while preserving the order. The ‘label’ parameter indicates the name of the channel. The “a:dcsa:” line specifies that this instance of the MSRP subprotocol being transported on the stream control transmission protocol (SCTP) association using the data channel with stream id 2 accepts plaintext files.

Features as described herein may generally relate to XR environments comprising large-scale spatial data. In an example, spatial data may be considered “large-scale” if the amount of data exceeds the processing and/or storage capacities of typical XR devices, and thus has particular organization, management, and/or storage requirements. Existing spatial computing systems face significant challenges in handling large-scale spatial data, particularly in complex environments with dense representations. The current approach of downloading and processing the entire spatial data set on the XR device may lead to several technical limitations, such as excessive bandwidth consumption, storage constraints, resource overburden, and/or inefficient data utilization.

With respect to excessive bandwidth consumption, it is noted that downloading large spatial data sets consumes significant bandwidth, resulting in slow loading times and potential network congestion. As spatial data grows in size and complexity, downloading the entire dataset becomes increasingly impractical and inefficient.

With respect to storage constraints, it is noted that storing and managing vast amounts of spatial data on the device requires significant storage space, posing a challenge for resource-constrained XR devices.

With respect to resource overburden, it is noted that processing and rendering massive amounts of spatial information overwhelms the XR device's resources, leading to lag and a poor user experience.

With respect to inefficient data utilization, it is noted that XR devices often only require a specific portion of the spatial data at any given time, leading to an unnecessary waste of bandwidth and processing power.

The current state of technology lacks a mechanism for efficient and dynamic management of large-scale spatial data in XR environments. This may result in several limitations, as described above.

A technical effect of example embodiments of the present disclosure may be to address management of large-scale spatial data in XR environments.

In an example embodiment, a spatial computing client (SCC) may dynamically define and signal spatial regions of interest (ROI) to a spatial computing server (SCS). A technical effect of example embodiments of the present disclosure may be to enable the SCS to selectively deliver only the necessary spatial data to the SCC. A technical effect of reducing the amount of spatial data delivered to the SCC may be optimizing bandwidth usage, reducing processing load, and/or improving the overall user experience.

In an example embodiment, an SCC may reconstruct a dense spatial map from a sparse map based, at least partially, on dynamic updates received from the SCS.

A technical effect of example embodiments of the present disclosure may be to facilitate efficient data management by reducing the amount of data stored on the device and minimizing the impact on the device resources.

In the present disclosure, the terms “spatial information”, “spatial data”, “spatial description”, and “spatial mapping data” may be used interchangeably. Spatial data, in the context of XR, refers to information about the physical environment and objects within it. This includes the shapes, sizes, and positions of objects in a three-dimensional space. It may involve creating a digital map of the physical environment. In AR, for example, spatial mapping allows virtual objects to be placed on real-world surfaces and interact with real objects.

In the present disclosure, the terms “spatial ROI”, “spatial volume of interest”, “area of interest”, and “ROI” may be used interchangeably.

In an example embodiment, an SCS may transmit spatial data to an SCC. In an example embodiment, the SCC may define a “spatial signal” to indicate one or more spatial regions of interest. In an example embodiment, a spatial region of interest may be described in a variety of ways and/or using a variety of formats. In an example embodiment, the SCC may send a query/request to the SCS requesting spatial information corresponding to the portion (e.g. spatial region of interest) indicated by the spatial signal. For example, the SCC may send, to the SCS, a request comprising at least one spatial signal, where the at least one spatial signal indicates at least one spatial ROI for which spatial data is being requested. In an example embodiment, the SCS may filter its spatial maps and returns only the relevant data within that portion (e.g. the spatial region of interest).

A SCS may be a 5G media streaming (5GMS) application server (AS), an IP multimedia subsystem (IMS) AS, a media function (MF), a data channel application server (DCAS), or a real time communication (RTC) AS. Additionally or alternatively, the SCS may be deployed on an edge node/AS, where it may aggregate the spatial ROI requests from multiple UEs and forward them to a cloud server. Upon receiving the requested ROIs from the cloud server, the SCS may then distribute the spatial data to each respective UE. An SCS may alternatively be referred to as a server apparatus, a server device, or a server network node. An apparatus or device comprising the SCS or performing the function of an SCS may also be referred to as an SCS.

A SCC may be a 5GMS client which may send spatial ROI requests using the hypertext transfer protocol (HTTP). The SCC may be an augmented reality multimedia telephone service for internet protocol multimedia subsystem (AR-MTSI) client or an RTC media client which may send spatial ROI requests over a data channel, or using another suitable transport protocol. The SCC may be any other client that uses spatial computing functions. An SCC may alternatively be referred to as a client apparatus, a client device, or a UE. An apparatus, device, or UE comprising the SCC may also be referred to as an SCC.

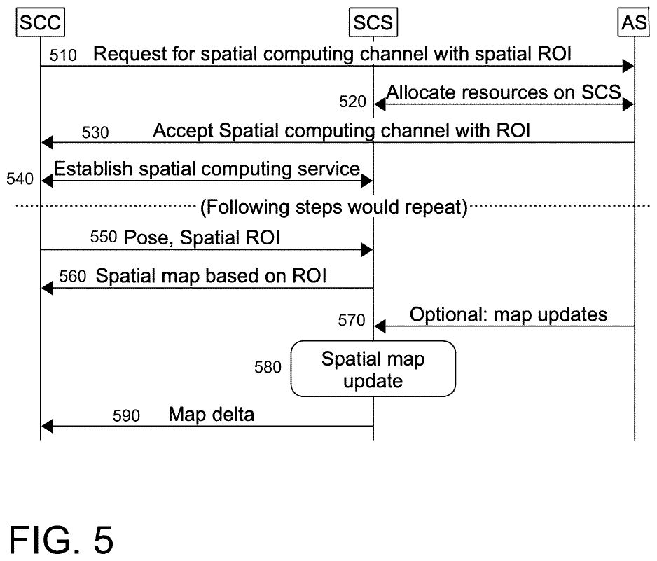

Before any spatial data is transmitted, the SCC may authenticate itself to the SCS using secure protocols. The SCS may verify the SCC's permissions to access specific spatial regions or types of spatial data. Exemplary procedures for spatial data requesting and transmission are shown in FIG. 5.

The role of the AS may be to negotiate a spatial computing service and allocate resources on an SCS. The AS may be an IMS AS, DCSF, 5GMS AS/AF or a 5G application provider. In some embodiments, the AS may be part of the SCS.

Referring now to FIG. 5, at 510 the SCS may transmit, to the AS, a request for a spatial computing channel with spatial ROI. After the AS accepts the ROI-based spatial map delivery, a spatial computing service may be established between the SCS and SCC. At 520, the AS may transmit, to the SCS, an allocation of resources for the SCS. At 530, the AS may transmit, to the SCC, an acceptance of the request for the spatial computing channel with ROI. At 540, the spatial computing service may be established between the SCC and the SCS.

After the session establishment, the SCC may continually request spatial ROIs from the SCS, e.g. via data channel messages or any other suitable protocol. The SCC may also include the user/device pose to the request/query, for example if the ROI is defined based on the user/device pose (e.g. based on device proximity to the ROI as described in one embodiment below). For example, at 550, the SCC may transmit, to the SCS, an indication of a pose and an indication of a spatial ROI. Additionally or alternatively, the SCC may include in a request a pose of a real object or a virtual object that may be used to define a spatial ROI.

Upon receiving a spatial ROI request, at 560 the SCS may send the corresponding spatial map to the SCC. To save bandwidth, the SCS may provide only a “map delta” to the SCC (i.e. an incremental update to an existing map). Optionally, at 570, the SCS may receive spatial map updates from the AS, which may be based on the historical data AS has collected from other devices or applications. At 580, spatial map update may be performed at the SCS. At 590, the SCS may send, to the SCC, a map delta, for example when available.

In an example embodiment, spatial ROI may be used after session negotiation has been performed. In case spatial ROI requests are delivered via a data channel (DC), a DC sub-protocol may be defined for spatial computing metadata, e.g. “3gpp-sc-metadata”, which may be included in the dcmap attribute of the SDP during session negotiation.

The ROI request may be defined as a new message type, e.g. “sc-roi”, that may be sent using the above DC protocol. Several requests can be combined in one message.

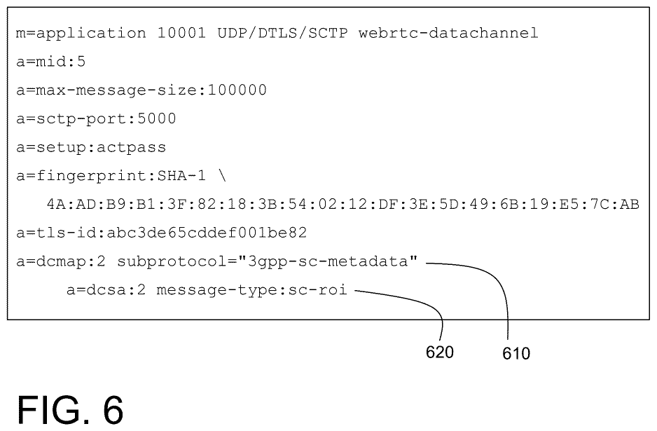

FIG. 6 illustrates an example session description, which includes an indication that a spatial ROI sub-protocol is defined (610) and an indication that a message type for ROI requests is defined (620). Note that only the relevant media description part is shown and other fields like originator and connection information are omitted for brevity.

In an example embodiment, a SCC may send spatial ROI requests for information that may be used to update a spatial map. The SCC may cache frequently accessed spatial data to reduce redundant queries. The SCC may send queries for multiple spatial regions simultaneously, and the SCS may handle and respond to these multi-region queries separately, or by combining the responses for efficiency reasons.

The SCS may predict and pre-fetch spatial data based on historical query patterns and/or anticipated needs (e.g., estimated motion trajectory of the SCC).

The SCC may request spatial data dynamically in real-time as the user moves through the environment. For example, the radius or shape of the ROI might expand when the user is moving quickly through the environment, or contract when stationary, which may have the technical effect of conserving resources.

The speed of the SCC may also determine the resolution (e.g. Level of Detail (LoD)) of the spatial data (e.g., a slower SCC speed may require fine grain spatial data delivery, as opposed to a higher SCC speed that may require only coarse resolution data delivery).

The SCC may also define an update frequency for an ROI.

The SCC may have already created, or received, a sparse spatial map for a specific environment on the device, e.g. a sparse point cloud representation of a room. When needed, it may request additional spatial data from the SCS that may allow it to obtain a dense point cloud from the sparse one for a requested spatial ROI.

The SCS may send incremental updates to the SCC, for example providing only the changes in the spatial data since the last query (“map delta”). The update may be request-response based and client-driven (i.e. using HTTP GET requests). In other words, the SCS may only provide an update to the SCC if a request for spatial ROI information is received by the SCS from the SCC. Alternatively, the SCC may subscribe to the spatial map service with an indication of the desired ROIs, and receive incremental updates from the SCS as new spatial data become available (e.g. provided by other devices in the same environment in a collaborative session) and/or as the client device moves inside the real world.

In an example embodiment, different spatial signals may be defined that may be utilized by an SCC to request one or more spatial ROIs.

In an example embodiment, the SCC may specify, with a spatial signal, a bounding volume to delineate the spatial ROIs for which the application seeks to receive spatial mapping data (e.g. a spatial description). The SCC may then send a query/request (e.g. including the spatial signal) to the SCS requesting the spatial data within that defined volume. The SCS may then filter its spatial map accordingly and return only the relevant spatial data.

The structure or shape of the bounding volume may be, for example, a cuboid, cylinder, an ellipsoid, a cone, etc. It may also be a custom mesh that precisely matches the ROI. A mesh is a collection of vertices, edges, and faces that defines the shape of a 3D object in computer graphics. The vertices represent points in 3D space, the edges connect pairs of vertices, and the faces (typically polygons such as triangles) define the surface of the object. A mesh may be considered a type of bounding volume that encloses a spatial ROI. The bounding volume is not limited by these examples; any bounding volume describing a volumetric portion of an environment may be used.

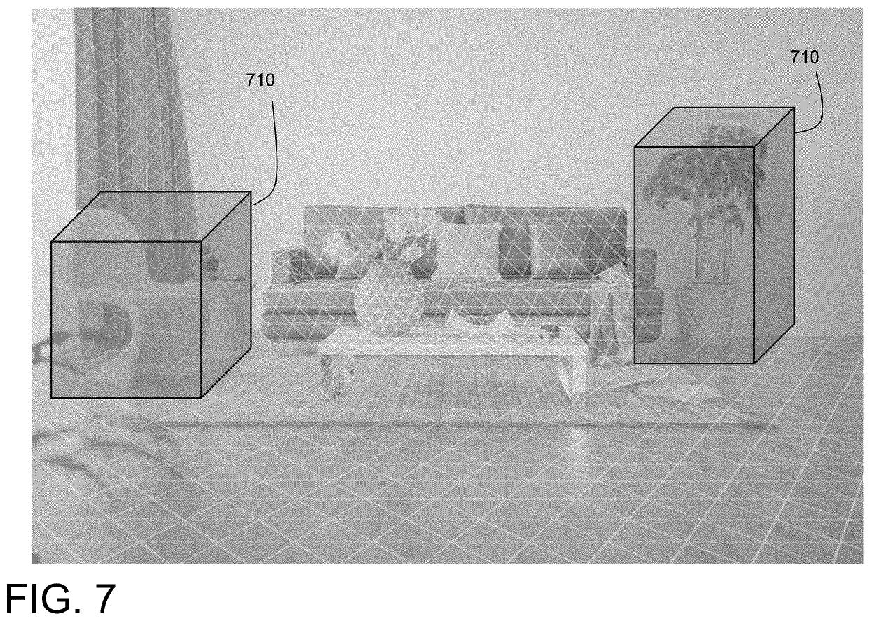

Referring now to FIG. 7, illustrated is an example of an environment with two bounding cuboids (710) defined by spatial signals.

In an example embodiment, the SCC may choose to request spatial data only for the visible area within the bounding volume. For instance, any portion of the volume that is obscured by a wall may be excluded from the spatial data provided by the SCS to the SCC.

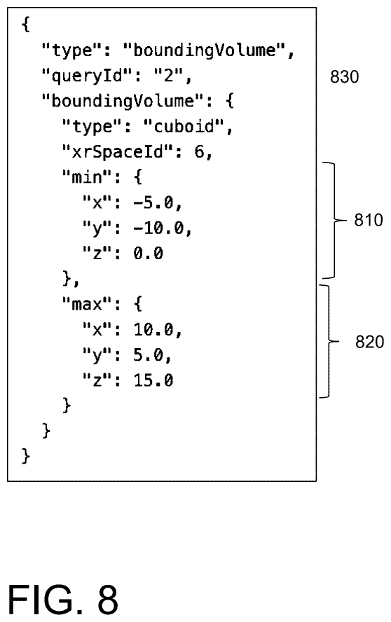

Referring now to FIG. 8, illustrated is an example of signaling, in JavaScript object notation (JSON) format, of a bounding volume describing a spatial ROI in an environment. In the example, two corner points of the cuboid are specified. The minimum point (810) may be the corner with the smallest x, y, z coordinates of the bounding volume; the maximum point (820) may be the opposite corner with the largest x, y, z coordinates of the bounding volume. The coordinates may be provided, for example in meters. An XR space ID may be provided to specify the coordinate system.

Note that the min/max points representation illustrated in FIG. 8 is only an exemplary way to specify a bounding volume. Another way to define a cuboid is by its center point and half-extents. The center point is the point at the center of the cuboid. Half-extents are the distances from the center point to the faces of the cuboid along each axis.

In FIG. 8, “query ID” (830) may be a unique identifier for this query or request, which may be useful for generating matching responses to queries at the SCS. The SCS may include this identifier in the response (e.g. including spatial data) to the request.

As illustrated in the example of FIG. 8, the query or request for a spatial ROI may further comprise an indication of a type of the query/request (e.g. bounding volume), a type of a bounding volume (e.g. cuboid), and/or an identifier of the environment (e.g. XR space ID).

In addition to JSON, any other suitable data interchange format may be used for signaling of a spatial signal, for example a spatial signal specifying a bounding volume or a different description of a spatial ROI according to an example embodiment of the present disclosure.

In computer graphics, raycasting is a technique used to determine what objects or surfaces in a 3D environment intersect with a line (ray) projected from a specific point in a particular direction. It is a fundamental operation in many computer graphics applications for 3D rendering and collision detection in virtual environments.

In an example embodiment, the SCC may send a spatial signal comprising a raycast query to the SCS, which may specify the origin and direction of the ray. The SCS may then return the spatial information intersected by the ray within the environment.

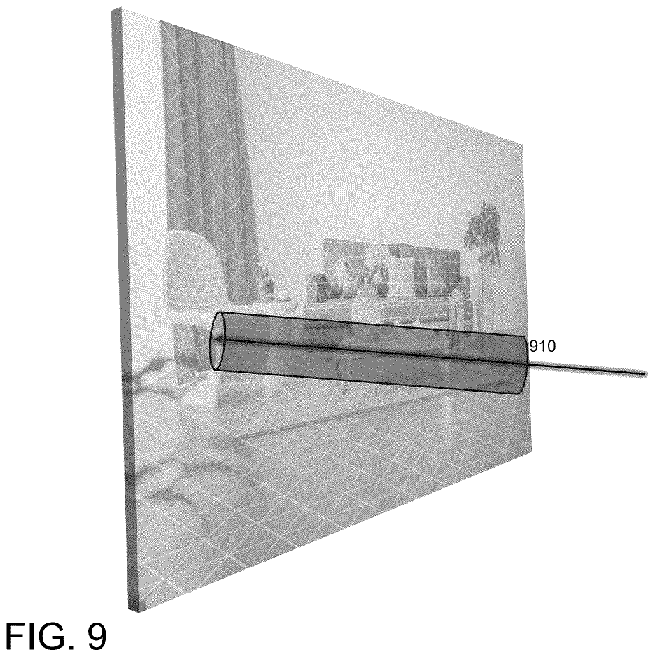

Referring now to FIG. 9, illustrated is an example of a raycast (910) with a cylindrical volume that may be used by an SCC to indicate a desired spatial ROI. The raycast may be defined, for example, with an origin, a direction, a shape of a bounding volume indicated by the raycast, and/or a radius.

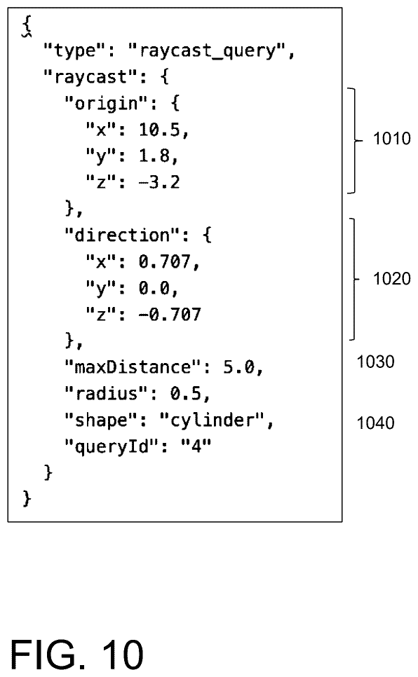

Referring now to FIG. 10, illustrated is an example of signaling of a raycast query. “origin” (1010) may be the starting point or origin of the ray in the 3D space/environment, which may be specified by x, y, and z coordinates. The direction of the ray may be given by a normalized unit vector “direction” (1020), specified by x, y, and z components. The maximum distance or range the ray may travel may be given by “maxDistance” (1030), which may be optional, but may limit the ROI. The parameter “shape” (1040) may specify the shape of the area around the ray (e.g. bounding volume). In the example of FIG. 10, “cylinder” may indicate a cylindrical volume around the ray (e.g. like a thick line). Another option may be, for example, “sphere”, which may be a spherical volume that moves along the ray (e.g. like a series of spheres). Another option may be a “cone”.

As illustrated in the example of FIG. 10, the query or request for a spatial ROI may further comprise a type of the query or request (e.g. raycast query), a radius of the raycast, and/or an identifier of the query.

Another option may be, for example, a cone. For a cone shaped raycast, the “maxDistance” may define the height of the cone. The “radius” may defines the radius of the base of the cone. The apex of the cone may be the user, i.e., “origin”, or it may be another point on the ray.

In another example embodiment, the SCC may request several raycast queries as a single query. In an example embodiment, the query may include a range for the origin and/or a range for the direction. In other words, a spatial signal comprising a range of origin values may be equivalent to a plurality of spatial signals each individually comprising an origin from the range of origin values. Similarly, a spatial signal comprising a range of directions may be equivalent to a plurality of spatial signals each individually comprising a direction from the range of direction values. Another parameter may optionally be included to indicate/determine the step with which the range is requested to be sampled. For example, 1.0 may be used to specify every integer position inside the range, while 0.1 may be used to specify a finer sampling of the range up to the first decimal, etc.

Optionally, a common radius may be defined in a request, such that all spatial signals included in the request may not need to include a radius parameter, but rather may request a spatial ROI that inherits the value of the common radius for definition of the spatial ROI. Optionally, a common shape may be defined in a request, such that all spatial signals included in the request may not need to include a shape parameter, but rather may request a spatial ROI that inherits the value of the common shape for definition of the spatial ROI.

In the context of XR, a spatial anchor is a virtual reference point that is used to map and track the position of digital objects in the physical world. These anchors allow digital content to be placed in a specific location within a physical environment and remain fixed to that location, even as the user moves around.

In an example embodiment, the SCC may specify one or more spatial anchors and request spatial information from the SCS within a region around the spatial anchors. For example, the SCC may indicate a fixed radius around the spatial anchors to define the boundaries of requested data (i.e. the spatial ROI). Alternatively, the SCC may define the boundaries of the requested spatial data by specifying an ROI radius around each spatial anchor (i.e. a separate ROI radius for each spatial ROI defined with a spatial anchor). The combination of the spatial anchor and radius may define a spherical volume of interest centered on each anchor point.

A spatial anchor may be defined with a spatial position (e.g. x, y, z coordinates) and an orientation (e.g. quaternion). A spatial anchor may also be defined with a radius, unless a common radius is defined in the request for all spatial signals defining spatial anchors.

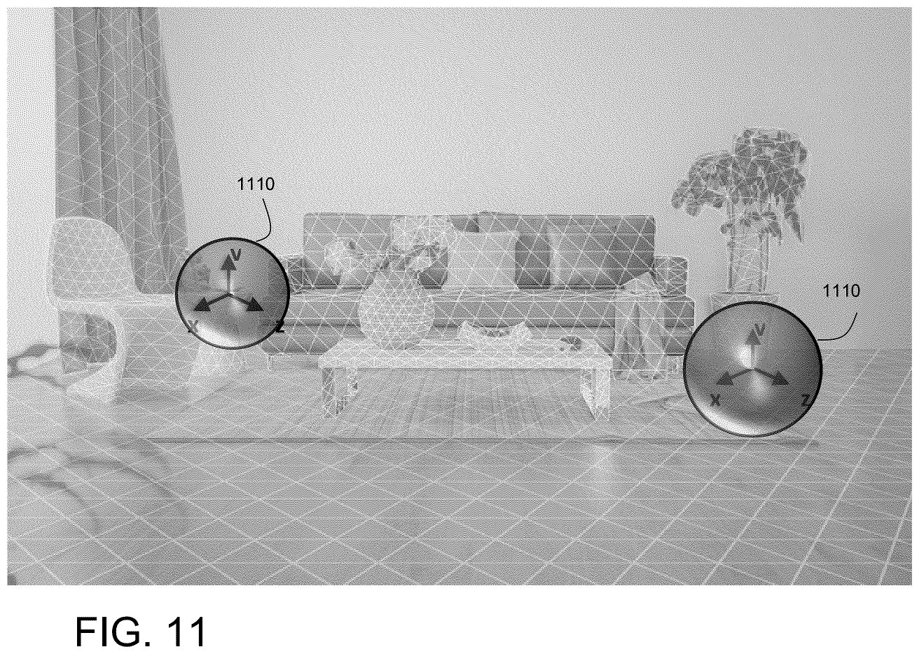

Referring now to FIG. 11, illustrated are two examples spatial anchors (1110) in 3D space with the requested ROI around them, shown as spheres in this non-limiting example. Other shapes or structures, besides spheres, may be used as a bounding volume about/around a spatial anchor defining the requested spatial ROI. For example, a cube may be used as a bounding volume around a spatial anchor; in such a case, a different parameter than a radius may be used to define the shape around the spatial anchor, for example a half-extent.

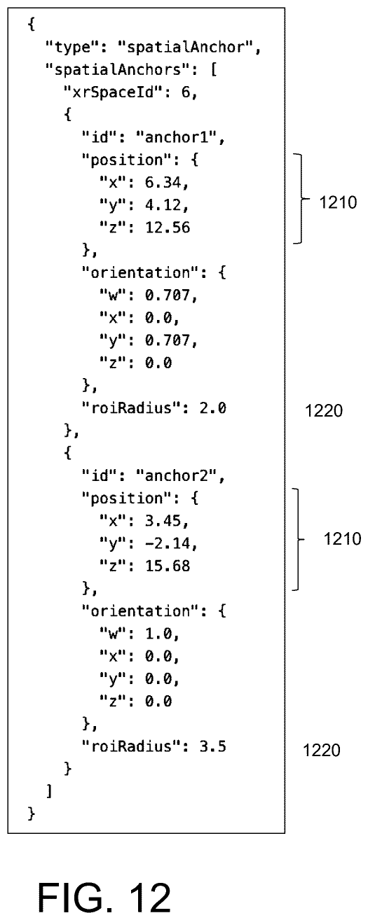

Referring now to FIG. 12, illustrated is an example of signaling of a spatial ROI query using spatial anchors. For each spatial ROI, a position of a spatial anchor (1210) and a radius (1220) of the spatial ROI around the spatial anchor may be defined.

As illustrated in the example of FIG. 12, the query or request for a spatial ROI may further comprise a type of the query or request (e.g. spatial anchor), an identifier of the XR space, and/or an orientation of a spatial anchor. The orientation may define the direction the spatial anchor is “facing” or how it's rotated. For example, if a chair is placed on the floor in AR, its orientation ensures the chair stays upright. The orientation may be used to “lock” the spatial anchor, and the bounding volume defining the spatial ROI around the spatial anchor, to the coordinate system.

Alternatively, a common radius may be specified that applies to all spatial anchors in a query.

The SCC may also use more complex geometries to delineate the area of interest, for example depending on the specific requirements of the application and the nature of the environment. For example, a request may consist of a mesh representation listing vertices and polygons that surround the area of interest.

Frustum culling is a technique used in computer graphics to improve rendering performance by discarding objects that are not visible to the camera. It works by utilizing the camera's view frustum, which may be a truncated pyramid-shaped volume that represents the visible region in 3D space.

In an example embodiment, the SCC may indicate, in a spatial signal, camera view frustum parameters that define the visible region in 3D space (i.e. a spatial ROI). For example, a spatial signal comprising a view frustum may comprise a spatial position parameter, an orientation parameter, a field of view parameter, an aspect ratio parameter, a distance to the near clipping plane parameter, and a distance to the far clipping plane parameter. The SCS may use the frustum to filter (similar to frustum culling) and transmit only the relevant spatial data to the SCC.

In an example embodiment, the SCS may adjust the resolution of the transmitted spatial data based on the SCC's view frustum. For objects far away from the camera, lower resolution spatial data may be transmitted, while higher resolution data may be sent for objects closer to the camera.

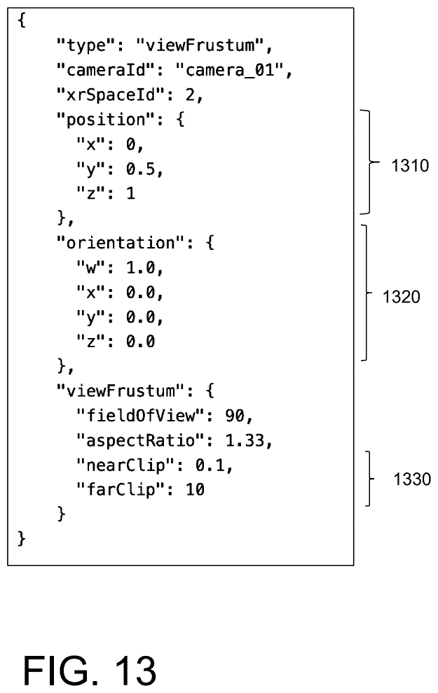

Referring now to FIG. 13, illustrated is an example of signaling of a view frustum query. The view frustum describing the requested spatial ROI may include a position (1310) of the view frustum/camera using x, y, and z coordinates in the environment. The view frustum describing the requested spatial ROI may also include an orientation/direction (1320) of the view frustum/camera using w, x, y, and z coordinates in the environment. The view frustum describing the requested spatial ROI may also include a distance to the near clipping plane and a distance to the far clipping plane of the camera (1330) which may describe a range or boundaries of the camera/frustum, for example how far the camera view extends and how close to the camera the camera view begins. In other words, the near clipping plane and the far clipping plane may describe the distance from the camera to the nearest/farthest point that is visible (e.g. included in the spatial ROI), respectively. Objects not within the range between the near clipping plane and the far clipping plane may not be included in the spatial data provided based on the spatial signal.

As illustrated in the example of FIG. 10, the query or request for a spatial ROI may further comprise a type of the query or request (e.g. view frustum query), an identifier of a camera/frustum, an identifier of the XR space/environment, a field of view, and/or an aspect ratio.

In an example embodiment, the SCC may request ROIs (using any type/format of spatial ROI request) based on another XR space or based on world coordinates (i.e. instead of using local/current XR space coordinates). This may be useful, for example, for a scenario where the user wants to teleport to another location. Specific metadata may be included with each request to indicate the coordinate system being used, for example if not a current coordinate system.

In an example embodiment, the SCC may indicate the desired ROI using any of the above signaling techniques and additionally may define a Level of Detail (LoD) for the ROI. This LoD may be represented as a numerical value or one of a predefined set of options (e.g., low, medium, high). The SCS may transmit the spatial information within the ROI at the requested LoD. For instance, the SCS may reduce the number of polygons or vertices for objects within the ROI to obtain the requested LoD (i.e. lower LoD).

In an example embodiment, the SCC may define regions based on depth thresholds or ranges, requesting spatial data only for objects within certain depth ranges or at varying LoDs depending on the depth. For example, if two objects are included in a bounding volume defined in a spatial signal, and a first object is in a first depth range while the second object is in a second, different depth range, the SCS may provide spatial data associated with the first object with a first LoD associated with the first depth range, and may provide spatial data associated with the second object with a second LoD associated with the second depth range. In another example, the SCC may request all available spatial data at a given a depth range at varying LoDs (e.g. without being constrained by a bounding volume).

For example, the SCC may request spatial data only for regions within a 5-meter radius of the device, centered on the user's current location or one of the specified spatial anchors. The radius may be set by the user or the system. If the user is moving, the SCS may transmit only the delta spatial data between the two spatial ROIs requested at different time points. For example, if spatial data for the same or overlapping spatial ROI are requested via two spatial signals within a predefined time range, the SCS may provide full spatial data in response to the first request, and delta information in response to the second request.

In an example embodiment, the SCC may associate multiple depth ranges with different priorities and LoDs. E.g. a) 0-5 m: Highest priority, highest LoD, b) 5-10 m: Medium priority, medium LoD, c) >10 m: Lowest priority, lowest LoD. The association between depth ranges and priorities/LoDs may be negotiated between the SCS and SCC during session establishment (see, e.g., 510-540 of FIG. 5).

In an example embodiment, in addition to ROI, the SCC may indicate user-defined interests during negotiation and/or in a request, i.e. specific categories or types of data within those regions. For example, a user may get/request more detailed spatial information of electronics shops in a shopping mall compared to clothing shops if the user indicated such an interest. For example, if the SCC transmits a request comprising a spatial signal indicating a spatial ROI comprising multiple portions that are each associated with a different user-defined interest, the SCS may only provide spatial data associated with the portion of the spatial ROI that is associated with a user-defined interest that was indicated during initial negotiation or with a spatial signal. In another example, the user may get more detailed spatial information near a basketball field compared to a tennis court in a sports complex based on indicated user-defined interests. This may have the technical effect of enabling more personalized and relevant spatial information retrieval, thereby reducing the bandwidth and resource usage. The user-defined interests may be specific to, or persist during a communication session.

In an example embodiment, if no user-defined interests are indicated by the SCC, the SCS may provide spatial data for requested spatial ROI regardless of the user-defined interests associated with the spatial ROI or portions of the spatial ROI. In other words, if no user-defined interests are indicated by the SCC, it may be assumed that any request is for all spatial data associated with a requested spatial ROI.

In an example embodiment, the SCC may define ROIs using semantic queries. Queries may be location-based, e.g. “all objects in the room X”, object-based, e.g. “all wall/floor/door objects” or attribute-based (e.g. color: “all red objects”, shape: “all round objects”), etc. The scene understanding module at the SCS may interpret the semantic queries, filter the relevant objects and transmit the corresponding spatial data to the SCC.

In an example embodiment, the scene understanding module may comprise one or more machine learning (ML) and/or artificial intelligence (AI) models. An example of an AI/ML model is a neural network. A neural network (NN) is a computation graph consisting of two or more layers of computation. Each layer may consist of one or more units, where each unit may perform an elementary computation. A unit may be connected to one or more other units, and the connection may have a weight associated with it. The weight may be used for scaling the signal passing through the associated connection. Weights may be learnable parameters, i.e., values which can be learned from training data. There may be other learnable parameters, such as those of batch-normalization layers.

In an example embodiment, there may be, in an environment, restricted zones for which any spatial data may be omitted, by the SCS, from a response to a request comprising a spatial signal received from the SCC. This restriction may come from user privileges, type, age, etc. The restricted zones may be specified by the application provider, network operator, or another user with higher privilege. For example, an “admin” user in a workplace may define such zones for users with normal privileges (i.e. non-admin privileges). In a family setting, an adult user may establish restricted zones to enhance child protection. Such restricted zones may be defined during negotiation of the session (see, e.g., 510-540 of FIG. 5).

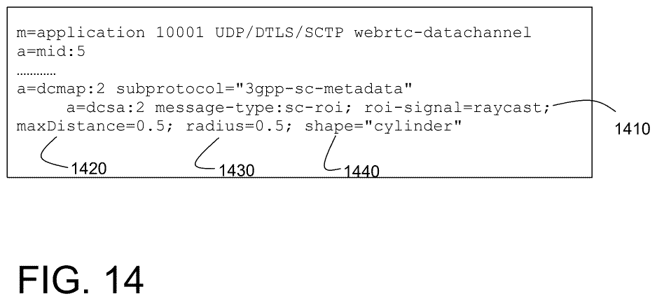

In an example embodiment, the format and parameters of the ROI may be negotiated at the start of the spatial computing session, and the ROI requests may only indicate an identifying point of the requested ROI, e.g. a camera pose, an anchor location or an origin of a bounding volume. In other words, the request may comprise a spatial signal including only one, or less than a full set, of parameters defining the spatial ROI for which spatial data is requested. An example (simplified) SDP description for a raycast ROI signal is illustrated in FIG. 14. As the example SDP description includes the type of the spatial ROI (1410), the maximum distance/range (1420), the radius (1430), and the shape (1440), the spatial signal may only include the origin and the direction, in contrast to FIG. 10.

In another example embodiment, only the ROI type may be negotiated during the SDP negotiation; the ROI parameters (e.g. maxDistance, radius above) may be set based on the first query sent by the SCC and used throughout the session. In other words, a first query/spatial signal transmitted/received during the session may include more parameters than subsequent queries/spatial signals transmitted/sent during the same session.

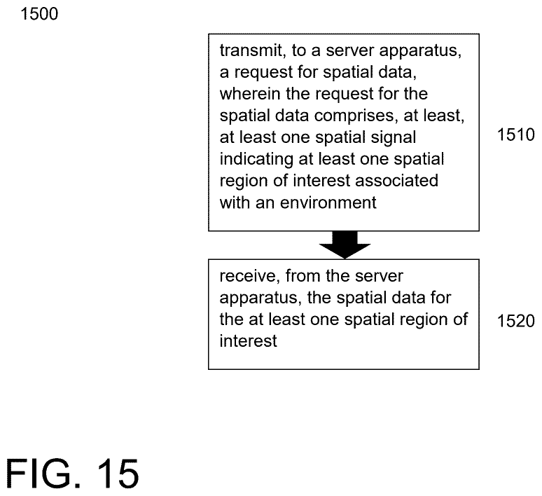

FIG. 15 illustrates the potential steps of an example method 1500. The example method 1500 may include: transmitting, to a server apparatus, a request for spatial data, wherein the request for the spatial data comprises, at least, at least one spatial signal indicating at least one spatial region of interest associated with an environment, 1510; and receiving, from the server apparatus, the spatial data for the at least one spatial region of interest, 1520. The example method 1500 may be performed, for example, with a SCC (which may be comprised by a UE), a 5G media streaming client, an augmented reality multimedia telephone service for internet protocol multimedia subsystem client, a real time communication media client, etc.

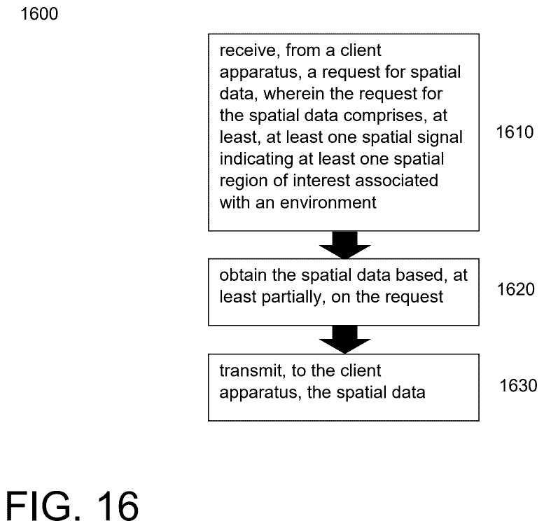

FIG. 16 illustrates the potential steps of an example method 1600. The example method 1600 may include: receiving, from a client apparatus, a request for spatial data, wherein the request for the spatial data comprises, at least, at least one spatial signal indicating at least one spatial region of interest associated with an environment, 1610; obtaining the spatial data based, at least partially, on the request, 1620; and transmitting, to the client apparatus, the spatial data, 1630. The example method 1600 may be performed, for example, with a SCS (which may be comprised by a base station), an application server, a 5G media streaming application server, an internet protocol multimedia subsystem application server, a media function, a data channel application server, a real time communication application server, an edge application server, etc.

In accordance with one example embodiment, an apparatus may comprise: at least one processor; and at least one memory storing instructions that, when executed by the at least one processor, cause the apparatus at least to: transmit, to a server apparatus, a request for spatial data, wherein the request for the spatial data may comprise, at least, at least one spatial signal indicating at least one spatial region of interest associated with an environment; and receive, from the server apparatus, the spatial data for the at least one spatial region of interest.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the example apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprises at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The request for the spatial data may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth range may define one or more priorities and one or more Level of Detail indications for the spatial data for the at least one spatial region of interest.

The example apparatus may be further configured to: transmit, to the server apparatus, an indication of at least one restricted zone in the environment.

The example apparatus may be further configured to: transmit, to the server apparatus, at least one user-defined interest.

The example apparatus may be further configured to: obtain a dense point cloud representation of the environment based, at least partially, on a sparse point cloud representation of the environment and the received spatial data.

The received spatial data may further comprise spatial data associated with a plurality of requests for spatial data transmitted by the example apparatus.

The example apparatus may be further configured to: transmit, to an application server, a request for a spatial computing channel with spatial regions of interest, wherein the request for the spatial computing channel with the spatial regions of interest may comprise, at least, a requested format for the at least one spatial signal; receive, from the application server, an acceptance of the spatial computing channel with the spatial regions of interest; and establish a spatial computing service with the server apparatus using the spatial computing channel with the spatial regions of interest.

The request for the spatial data may be transmitted via a data channel.

At least one of a size or a shape of the at least one spatial region of interest may be determined based, at least partially, on at least one of: an amount a user of the example apparatus moves, or an amount of movement of the example apparatus.

The environment may comprise a real-world environment.

The example apparatus may be located in the environment.

The example apparatus may be located in an environment that is at least partially different from the environment with which the at least one spatial region of interest is associated.

The example apparatus may be further configured to: perform rendering of virtual content in the environment based, at least partially, on the received spatial data.

The example apparatus may comprise at least one of: a 5G media streaming client, an augmented reality multimedia telephone service for internet protocol multimedia subsystem client, a real time communication media client, or a spatial computing client.

A user equipment may comprise the example apparatus.

The server apparatus may comprise at least one of: an application server, a 5G media streaming application server, an internet protocol multimedia subsystem application server, a media function, a data channel application server, a real time communication application server, an edge application server, or a spatial computing server.

In accordance with one aspect, an example method may be provided comprising: transmitting, with a client apparatus to a server apparatus, a request for spatial data, wherein the request for the spatial data may comprise, at least, at least one spatial signal indicating at least one spatial region of interest associated with an environment; and receiving, from the server apparatus, the spatial data for the at least one spatial region of interest.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprises at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The request for the spatial data may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth range may define one or more priorities and one or more Level of Detail indications for the spatial data for the at least one spatial region of interest.

The example method may further comprise: transmitting, to the server apparatus, an indication of at least one restricted zone in the environment.

The example method may further comprise: transmitting, to the server apparatus, at least one user-defined interest.

The example method may further comprise: obtaining a dense point cloud representation of the environment based, at least partially, on a sparse point cloud representation of the environment and the received spatial data.

The received spatial data may further comprise spatial data associated with a plurality of requests for spatial data transmitted by the client apparatus.

The example method may further comprise: transmitting, to an application server, a request for a spatial computing channel with spatial regions of interest, wherein the request for the spatial computing channel with the spatial regions of interest may comprise, at least, a requested format for the at least one spatial signal; receiving, from the application server, an acceptance of the spatial computing channel with the spatial regions of interest; and establishing a spatial computing service with the server apparatus using the spatial computing channel with the spatial regions of interest.

The request for the spatial data may be transmitted via a data channel.

At least one of a size or a shape of the at least one spatial region of interest may be determined based, at least partially, on at least one of: an amount a user of the client apparatus moves, or an amount of movement of the client apparatus.

The environment may comprise a real-world environment.

The client apparatus may be located in the environment.

The client apparatus may be located in an environment that is at least partially different from the environment with which the at least one spatial region of interest is associated.

The example method may further comprise: performing rendering of virtual content in the environment based, at least partially, on the received spatial data.

The client apparatus may comprise at least one of: a 5G media streaming client, an augmented reality multimedia telephone service for internet protocol multimedia subsystem client, a real time communication media client, or a spatial computing client.

A user equipment may comprise the client apparatus.

The server apparatus may comprise at least one of: an application server, a 5G media streaming application server, an internet protocol multimedia subsystem application server, a media function, a data channel application server, a real time communication application server, an edge application server, or a spatial computing server.

In accordance with one example embodiment, an apparatus may comprise: circuitry configured to perform: transmitting, with a client apparatus to a server apparatus, a request for spatial data, wherein the request for the spatial data may comprise, at least, at least one spatial signal indicating at least one spatial region of interest associated with an environment; and circuitry configured to perform: receiving, from the server apparatus, the spatial data for the at least one spatial region of interest.

In accordance with one example embodiment, an apparatus may comprise: processing circuitry; memory circuitry including computer program code, the memory circuitry and the computer program code configured to, with the processing circuitry, enable the apparatus to: transmit, to a server apparatus, a request for spatial data, wherein the request for the spatial data may comprise, at least, at least one spatial signal indicating at least one spatial region of interest associated with an environment; and receive, from the server apparatus, the spatial data for the at least one spatial region of interest.

As used in this application, the term “circuitry” or “means” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: transmitting, to a server apparatus, a request for spatial data, wherein the request for the spatial data may comprise, at least, at least one spatial signal indicating at least one spatial region of interest associated with an environment; and receiving, from the server apparatus, the spatial data for the at least one spatial region of interest.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the example apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprises at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The request for the spatial data may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth range may define one or more priorities and one or more Level of Detail indications for the spatial data for the at least one spatial region of interest.

The means may be further configured for: transmitting, to the server apparatus, an indication of at least one restricted zone in the environment.

The means may be further configured for: transmitting, to the server apparatus, at least one user-defined interest.

The means may be further configured for: obtaining a dense point cloud representation of the environment based, at least partially, on a sparse point cloud representation of the environment and the received spatial data.

The received spatial data may further comprise spatial data associated with a plurality of requests for spatial data transmitted by the example apparatus.

The means may be further configured for: transmitting, to an application server, a request for a spatial computing channel with spatial regions of interest, wherein the request for the spatial computing channel with the spatial regions of interest may comprise, at least, a requested format for the at least one spatial signal; receiving, from the application server, an acceptance of the spatial computing channel with the spatial regions of interest; and establishing a spatial computing service with the server apparatus using the spatial computing channel with the spatial regions of interest.

The request for the spatial data may be transmitted via a data channel.

At least one of a size or a shape of the at least one spatial region of interest may be determined based, at least partially, on at least one of: an amount a user of the example apparatus moves, or an amount of movement of the example apparatus.

The environment may comprise a real-world environment.

The example apparatus may be located in the environment.

The example apparatus may be located in an environment that is at least partially different from the environment with which the at least one spatial region of interest is associated.

The means may be further configured for: performing rendering of virtual content in the environment based, at least partially, on the received spatial data.

The example apparatus may comprise at least one of: a 5G media streaming client, an augmented reality multimedia telephone service for internet protocol multimedia subsystem client, a real time communication media client, or a spatial computing client.

A user equipment may comprise the example apparatus.

The server apparatus may comprise at least one of: an application server, a 5G media streaming application server, an internet protocol multimedia subsystem application server, a media function, a data channel application server, a real time communication application server, an edge application server, or a spatial computing server.

A processor, memory, and/or example algorithms (which may be encoded as instructions, program, or code) may be provided as example means for providing or causing performance of operation.

In accordance with one example embodiment, a (non-transitory) computer-readable medium comprising instructions stored thereon which, when executed with at least one processor, cause the at least one processor to: cause transmitting, with a client apparatus to a server apparatus, of a request for spatial data, wherein the request for the spatial data may comprise, at least, at least one spatial signal indicating at least one spatial region of interest associated with an environment; and cause receiving, from the server apparatus, of the spatial data for the at least one spatial region of interest.

In accordance with one example embodiment, a (non-transitory) computer-readable medium comprising program instructions stored thereon for performing at least the following: causing transmitting, with a client apparatus to a server apparatus, of a request for spatial data, wherein the request for the spatial data may comprise, at least, at least one spatial signal indicating at least one spatial region of interest associated with an environment; and causing receiving, from the server apparatus, of the spatial data for the at least one spatial region of interest.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprises at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The request for the spatial data may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth range may define one or more priorities and one or more Level of Detail indications for the spatial data for the at least one spatial region of interest.

The example computer-readable medium may further comprise program instructions stored thereon for performing: causing transmitting, to the server apparatus, of an indication of at least one restricted zone in the environment.

The example computer-readable medium may further comprise program instructions stored thereon for performing: causing transmitting, to the server apparatus, of at least one user-defined interest.

The example computer-readable medium may further comprise program instructions stored thereon for performing: causing obtaining of a dense point cloud representation of the environment based, at least partially, on a sparse point cloud representation of the environment and the received spatial data.

The received spatial data may further comprise spatial data associated with a plurality of requests for spatial data transmitted by the client apparatus.

The example computer-readable medium may further comprise program instructions stored thereon for performing: causing transmitting, to an application server, of a request for a spatial computing channel with spatial regions of interest, wherein the request for the spatial computing channel with the spatial regions of interest may comprise, at least, a requested format for the at least one spatial signal; causing receiving, from the application server, of an acceptance of the spatial computing channel with the spatial regions of interest; and establishing a spatial computing service with the server apparatus using the spatial computing channel with the spatial regions of interest.

The request for the spatial data may be transmitted via a data channel.

At least one of a size or a shape of the at least one spatial region of interest may be determined based, at least partially, on at least one of: an amount a user of the client apparatus moves, or an amount of movement of the client apparatus.

The environment may comprise a real-world environment.

The client apparatus may be located in the environment.

The client apparatus may be located in an environment that is at least partially different from the environment with which the at least one spatial region of interest is associated.

The example computer-readable medium may further comprise program instructions stored thereon for performing: rendering of virtual content in the environment based, at least partially, on the received spatial data.

The client apparatus may comprise at least one of: a 5G media streaming client, an augmented reality multimedia telephone service for internet protocol multimedia subsystem client, a real time communication media client, or a spatial computing client.

A user equipment may comprise the client apparatus.

The server apparatus may comprise at least one of: an application server, a 5G media streaming application server, an internet protocol multimedia subsystem application server, a media function, a data channel application server, a real time communication application server, an edge application server, or a spatial computing server.

In accordance with another example embodiment, a (non-transitory) program storage device readable by a machine may be provided, tangibly embodying instructions executable by the machine for performing operations, the operations comprising: causing transmitting, with a client apparatus to a server apparatus, of a request for spatial data, wherein the request for the spatial data may comprise, at least, at least one spatial signal indicating at least one spatial region of interest associated with an environment; and causing receiving, from the server apparatus, of the spatial data for the at least one spatial region of interest.

In accordance with another example embodiment, a (non-transitory) computer-readable medium comprising instructions that, when executed by an apparatus, cause the apparatus to perform at least the following: causing transmitting, with a client apparatus to a server apparatus, of a request for spatial data, wherein the request for the spatial data may comprise, at least, at least one spatial signal indicating at least one spatial region of interest associated with an environment; and causing receiving, from the server apparatus, of the spatial data for the at least one spatial region of interest.

A computer implemented system comprising: at least one processor and at least one (non-transitory) memory storing instructions that, when executed by the at least one processor, cause the system at least to perform: causing transmitting, with a client apparatus to a server apparatus, of a request for spatial data, wherein the request for the spatial data may comprise, at least, at least one spatial signal indicating at least one spatial region of interest associated with an environment; and causing receiving, from the server apparatus, of the spatial data for the at least one spatial region of interest.

A computer implemented system comprising: means for causing transmitting, with a client apparatus to a server apparatus, of a request for spatial data, wherein the request for the spatial data may comprise, at least, at least one spatial signal indicating at least one spatial region of interest associated with an environment; and means for causing receiving, from the server apparatus, of the spatial data for the at least one spatial region of interest.

In accordance with one example embodiment, an apparatus may comprise: at least one processor; and at least one memory storing instructions that, when executed by the at least one processor, cause the apparatus at least to: receive, from a client apparatus, a request for spatial data, wherein the request for the spatial data may comprise, at least, at least one spatial signal indicating at least one spatial region of interest associated with an environment; obtain the spatial data based, at least partially, on the request; and transmit, to the client apparatus, the spatial data.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprise at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The at least one spatial signal may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth may define one or more priorities and one or more Level of Detail indications for the spatial data for the at least one spatial region of interest.

The example apparatus may be further configured to: receive, from the client apparatus, an indication of at least one restricted zone in the environment.

The spatial data may be obtained based, at least partially, on at least one restricted zone defined in the environment.

The example apparatus may be further configured to: receive, from the client apparatus, at least one user-defined interest.

Obtaining the spatial data may comprise the example apparatus being further configured to: determine the spatial data based, at least partially, on the at least one user-defined interest.

Obtaining the spatial data may comprise the example apparatus being further configured to: determine a subset of spatial data describing the environment based, at least partially, on the request, wherein the spatial data may comprise the determined subset of the spatial data describing the environment.

Determining the subset of the spatial data describing the environment may comprise the example apparatus being further configured to: filter the spatial data describing the environment to determine the subset.

The example apparatus may be further configured to: receive, from an application server apparatus, the spatial data describing the environment.

The example apparatus may be further configured to: receive, from the application server apparatus, one or more updates to the spatial data describing the environment.

The example apparatus may be further configured to: determine based, at least partially, on the request, an estimated request for further spatial data; and obtain the further spatial data based, at least partially, on the estimated request.

The transmitted spatial data may further comprise spatial data associated with a plurality of requests received from the client apparatus.

The example apparatus may be further configured to: adjust a resolution of the spatial data based, at least partially, on the request.

The example apparatus may comprise an application server apparatus, and the example apparatus may be further configured to: receive, from the client apparatus, a request for a spatial computing channel with spatial regions of interest, wherein the request for the spatial computing channel with the spatial regions of interest may comprise, at least, a requested format for the at least one spatial signal; transmit, to the client apparatus, an acceptance of the spatial computing channel with the spatial regions of interest; and establish a spatial computing service with the client apparatus using the spatial computing channel with the spatial regions of interest.

The request may be received via a data channel.

The example apparatus may comprise at least one of: an application server, a 5G media streaming application server, an internet protocol multimedia subsystem application server, a media function, a data channel application server, a real time communication application server, an edge application server, or a spatial computing server.

The client apparatus may comprises at least one of: a 5G media streaming client, an augmented reality multimedia telephone service for internet protocol multimedia subsystem client, a real time communication media client, or a spatial computing client.

In accordance with one aspect, an example method may be provided comprising: receiving, with a server apparatus from a client apparatus, a request for spatial data, wherein the request for the spatial data may comprise, at least, at least one spatial signal indicating at least one spatial region of interest associated with an environment; obtaining the spatial data based, at least partially, on the request; and transmitting, to the client apparatus, the spatial data.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprise at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The at least one spatial signal may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth may define one or more priorities and one or more Level of Detail indications for the spatial data for the at least one spatial region of interest.

The example method may further comprise: receiving, from the client apparatus, an indication of at least one restricted zone in the environment.

The spatial data may be obtained based, at least partially, on at least one restricted zone defined in the environment.

The example method may further comprise: receiving, from the client apparatus, at least one user-defined interest.

The obtaining of the spatial data may comprise: determining the spatial data based, at least partially, on the at least one user-defined interest.

The obtaining of the spatial data may comprise: determining a subset of spatial data describing the environment based, at least partially, on the request, wherein the spatial data may comprise the determined subset of the spatial data describing the environment.

The determining of the subset of the spatial data describing the environment may comprise: filtering the spatial data describing the environment to determine the subset.

The example method may further comprise: receiving, from an application server apparatus, the spatial data describing the environment.

The example method may further comprise: receiving, from the application server apparatus, one or more updates to the spatial data describing the environment.

The example method may further comprise: determining based, at least partially, on the request, an estimated request for further spatial data; and obtaining the further spatial data based, at least partially, on the estimated request.

The transmitted spatial data may further comprise spatial data associated with a plurality of requests received from the client apparatus.

The example method may further comprise: adjusting a resolution of the spatial data based, at least partially, on the request.

The server apparatus may comprise an application server apparatus, and the example method may further comprise: receiving, from the client apparatus, a request for a spatial computing channel with spatial regions of interest, wherein the request for the spatial computing channel with the spatial regions of interest may comprise, at least, a requested format for the at least one spatial signal; transmitting, to the client apparatus, an acceptance of the spatial computing channel with the spatial regions of interest; and establishing a spatial computing service with the client apparatus using the spatial computing channel with the spatial regions of interest.

The request may be received via a data channel.

The server apparatus may comprise at least one of: an application server, a 5G media streaming application server, an internet protocol multimedia subsystem application server, a media function, a data channel application server, a real time communication application server, an edge application server, or a spatial computing server.

The client apparatus may comprise at least one of: a 5G media streaming client, an augmented reality multimedia telephone service for internet protocol multimedia subsystem client, a real time communication media client, or a spatial computing client.

In accordance with one example embodiment, an apparatus may comprise: circuitry configured to perform: receiving, with a server apparatus from a client apparatus, a request for spatial data, wherein the request for the spatial data may comprise, at least, at least one spatial signal indicating at least one spatial region of interest associated with an environment; circuitry configured to perform: obtaining the spatial data based, at least partially, on the request; and circuitry configured to perform: transmitting, to the client apparatus, the spatial data.

In accordance with one example embodiment, an apparatus may comprise: processing circuitry; memory circuitry including computer program code, the memory circuitry and the computer program code configured to, with the processing circuitry, enable the apparatus to: receive, from a client apparatus, a request for spatial data, wherein the request for the spatial data may comprise, at least, at least one spatial signal indicating at least one spatial region of interest associated with an environment; obtain the spatial data based, at least partially, on the request; and transmit, to the client apparatus, the spatial data.

In accordance with one example embodiment, an apparatus may comprise means for: receiving, from a client apparatus, a request for spatial data, wherein the request for the spatial data may comprise, at least, at least one spatial signal indicating at least one spatial region of interest associated with an environment; obtaining the spatial data based, at least partially, on the request; and transmitting, to the client apparatus, the spatial data.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprise at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The at least one spatial signal may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth may define one or more priorities and one or more Level of Detail indications for the spatial data for the at least one spatial region of interest.

The means may be further configured for: receiving, from the client apparatus, an indication of at least one restricted zone in the environment.

The spatial data may be obtained based, at least partially, on at least one restricted zone defined in the environment.

The means may be further configured for: receiving, from the client apparatus, at least one user-defined interest.

The means configured for obtaining the spatial data may comprise means configured for: determining the spatial data based, at least partially, on the at least one user-defined interest.

The means configured for obtaining the spatial data may comprise mean configured for: determining a subset of spatial data describing the environment based, at least partially, on the request, wherein the spatial data may comprise the determined subset of the spatial data describing the environment.

The means configured for determining the subset of the spatial data describing the environment may comprise means configured for: filtering the spatial data describing the environment to determine the subset.

The means may be further configured for: receiving, from an application server apparatus, the spatial data describing the environment.

The means may be further configured for: receiving, from the application server apparatus, one or more updates to the spatial data describing the environment.

The means may be further configured for: determining based, at least partially, on the request, an estimated request for further spatial data; and obtaining the further spatial data based, at least partially, on the estimated request.

The transmitted spatial data may further comprise spatial data associated with a plurality of requests received from the client apparatus.

The means may be further configured for: adjusting a resolution of the spatial data based, at least partially, on the request.

The example apparatus may comprise an application server apparatus, and the means may be further configured for: receiving, from the client apparatus, a request for a spatial computing channel with spatial regions of interest, wherein the request for the spatial computing channel with the spatial regions of interest may comprise, at least, a requested format for the at least one spatial signal; transmitting, to the client apparatus, an acceptance of the spatial computing channel with the spatial regions of interest; and establishing a spatial computing service with the client apparatus using the spatial computing channel with the spatial regions of interest.

The request may be received via a data channel.

The apparatus may comprise at least one of: an application server, a 5G media streaming application server, an internet protocol multimedia subsystem application server, a media function, a data channel application server, a real time communication application server, an edge application server, or a spatial computing server.

The client apparatus may comprise at least one of: a 5G media streaming client, an augmented reality multimedia telephone service for internet protocol multimedia subsystem client, a real time communication media client, or a spatial computing client.

A processor, memory, and/or example algorithms (which may be encoded as instructions, program, or code) may be provided as example means for providing or causing performance of operation.

In accordance with one example embodiment, a (non-transitory) computer-readable medium comprising instructions stored thereon which, when executed with at least one processor, cause the at least one processor to: cause receiving, with a server apparatus from a client apparatus, of a request for spatial data, wherein the request for the spatial data may comprise, at least, at least one spatial signal indicating at least one spatial region of interest associated with an environment; cause obtaining the spatial data based, of at least partially, on the request; and cause transmitting, to the client apparatus, of the spatial data.

In accordance with one example embodiment, a (non-transitory) computer-readable medium comprising program instructions stored thereon for performing at least the following: causing receiving, with a server apparatus from a client apparatus, of a request for spatial data, wherein the request for the spatial data may comprise, at least, at least one spatial signal indicating at least one spatial region of interest associated with an environment; causing obtaining the spatial data based, of at least partially, on the request; and causing transmitting, to the client apparatus, of the spatial data.

The at least one spatial signal indicating the at least one spatial region of interest may comprise at least one of: at least one bounding volume describing the at least one spatial region of interest, at least one raycast describing the at least one spatial region of interest, at least one spatial anchor describing the at least one spatial region of interest, at least one mesh representation describing the at least one spatial region of interest, at least one view frustum describing the at least one spatial region of interest, a difference from a previously transmitted request for spatial data of one or more spatial regions of interest, at least one semantic query describing the at least one spatial region of interest, a user pose describing the at least one spatial region of interest, a pose of the client apparatus describing the at least one spatial region of interest, a pose of a real object describing the at least one spatial region of interest, or a pose of a virtual object describing the at least one spatial region of interest.

A structure of the at least one bounding volume may comprise at least one of: a cuboid, a cylinder, an ellipsoid, a cone, or a mesh.

The at least one bounding volume may comprise at least one of: a set of coordinates, or a center point and at least one half-extent.

The at least one raycast may comprise at least: at least one origin, and at least one direction.

The at least one raycast may further comprise at least one radius.

The at least one spatial signal may comprise the at least one raycast, wherein the request may further comprise an indication of a common radius value for respective ones of the at least one raycast.

The at least one raycast may further comprise at least one shape of at least one bounding volume indicated with the at least one raycast, wherein the at least one shape may comprise at least one of: a cylinder, a sphere, or a cone.

The at least one spatial signal may comprise the at least one raycast, wherein the request may further comprise an indication of a common shape for a bounding volume for respective ones of the at least one raycast.

The at least one raycast may further comprise at least one of: a range of origin values, a sampling rate for the range of origin values, a range of direction values, a sampling rate for the range of direction values, or at least one maximum distance.

The at least one spatial anchor may comprise at least: at least one position, and at least one orientation.

The at least one spatial anchor may further comprise at least one radius value.

The at least one spatial signal may comprise the at least one spatial anchor, wherein the request may further comprise an indication of a common radius value for respective ones of the at least one spatial anchor.

The at least one view frustum may comprise at least: at least one position, at least one orientation, at least one field of view, at least one aspect ratio value, at least one distance to a near clipping plane, and at least one distance to a far clipping plane.

The spatial data may comprise at least one of: a spatial map, an update to previously received spatial data, an extension of at least one boundary of the previously received spatial data, or additional detail for the previously received spatial data.

The at least one spatial signal may further comprise at least one of: a requested update frequency for the spatial data of the at least one spatial region of interest, a request for current spatial data for the at least one spatial region of interest, a request for a visible area within the at least one spatial region of interest, a request to subscribe to updates with respect to the at least one spatial region of interest, an identifier of the environment, an identifier of the request, an identifier of a coordinate system associated with the environment, at least one Level of Detail indication, or at least one depth range further defining the at least one spatial region of interest.

Respective ones of the at least one depth may define one or more priorities and one or more Level of Detail indications for the spatial data for the at least one spatial region of interest.

The example computer-readable medium may further comprise program instructions stored thereon for performing: causing receiving, from the client apparatus, of an indication of at least one restricted zone in the environment.

The spatial data may be obtained based, at least partially, on at least one restricted zone defined in the environment.

The example computer-readable medium may further comprise program instructions stored thereon for performing: causing receiving, from the client apparatus, of at least one user-defined interest.

The program instructions for performing causing obtaining of the spatial data may comprise program instructions for performing: determining the spatial data based, at least partially, on the at least one user-defined interest.

The program instructions for performing causing obtaining of the spatial data may comprise program instructions for performing: determining a subset of spatial data describing the environment based, at least partially, on the request, wherein the spatial data may comprise the determined subset of the spatial data describing the environment.

The program instructions for performing determining the subset of the spatial data describing the environment may comprise program instructions for performing: filtering the spatial data describing the environment to determine the subset.

The example computer-readable medium may further comprise program instructions stored thereon for performing: causing receiving, from an application server apparatus, of the spatial data describing the environment.

The example computer-readable medium may further comprise program instructions stored thereon for performing: causing receiving, from the application server apparatus, one or more updates to the spatial data describing the environment.

The example computer-readable medium may further comprise program instructions stored thereon for performing: determining based, at least partially, on the request, an estimated request for further spatial data; and causing obtaining of the further spatial data based, at least partially, on the estimated request.

The transmitted spatial data may further comprise spatial data associated with a plurality of requests received from the client apparatus.

The example computer-readable medium may further comprise program instructions stored thereon for performing: adjusting a resolution of the spatial data based, at least partially, on the request.

The server apparatus may comprise an application server apparatus, and the program instructions stored thereon may be further for performing: causing receiving, from the client apparatus, of a request for a spatial computing channel with spatial regions of interest, wherein the request for the spatial computing channel with the spatial regions of interest may comprise, at least, a requested format for the at least one spatial signal; causing transmitting, to the client apparatus, of an acceptance of the spatial computing channel with the spatial regions of interest; and establishing a spatial computing service with the client apparatus using the spatial computing channel with the spatial regions of interest.

The request may be received via a data channel.

The server apparatus may comprise at least one of: an application server, a 5G media streaming application server, an internet protocol multimedia subsystem application server, a media function, a data channel application server, a real time communication application server, an edge application server, or a spatial computing server.

The client apparatus may comprise at least one of: a 5G media streaming client, an augmented reality multimedia telephone service for internet protocol multimedia subsystem client, a real time communication media client, or a spatial computing client.

In accordance with another example embodiment, a (non-transitory) program storage device readable by a machine may be provided, tangibly embodying instructions executable by the machine for performing operations, the operations comprising: causing receiving, with a server apparatus from a client apparatus, of a request for spatial data, wherein the request for the spatial data may comprise, at least, at least one spatial signal indicating at least one spatial region of interest associated with an environment; causing obtaining the spatial data based, of at least partially, on the request; and causing transmitting, to the client apparatus, of the spatial data.

In accordance with another example embodiment, a (non-transitory) computer-readable medium comprising instructions that, when executed by an apparatus, cause the apparatus to perform at least the following: causing receiving, with a server apparatus from a client apparatus, of a request for spatial data, wherein the request for the spatial data may comprise, at least, at least one spatial signal indicating at least one spatial region of interest associated with an environment; causing obtaining the spatial data based, of at least partially, on the request; and causing transmitting, to the client apparatus, of the spatial data.

A computer implemented system comprising: at least one processor and at least one (non-transitory) memory storing instructions that, when executed by the at least one processor, cause the system at least to perform: causing receiving, with a server apparatus from a client apparatus, of a request for spatial data, wherein the request for the spatial data may comprise, at least, at least one spatial signal indicating at least one spatial region of interest associated with an environment; causing obtaining the spatial data based, of at least partially, on the request; and causing transmitting, to the client apparatus, of the spatial data.

A computer implemented system comprising: means for causing receiving, with a server apparatus from a client apparatus, of a request for spatial data, wherein the request for the spatial data may comprise, at least, at least one spatial signal indicating at least one spatial region of interest associated with an environment; means for causing obtaining the spatial data based, of at least partially, on the request; and means for causing transmitting, to the client apparatus, of the spatial data.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising: at least one processor; and at least one memory storing instructions that, when executed with the at least one processor, cause the apparatus at least to: transmit, to a server apparatus, a request for spatial data, wherein the request for the spatial data comprises, at least, at least one spatial signal indicating at least one spatial region of interest associated with an environment; and receive, from the server apparatus, the spatial data for the at least one spatial region of interest.

2. The apparatus of claim 1, wherein the at least one spatial signal indicating the at least one spatial region of interest comprises at least one of: at least one bounding volume describing the at least one spatial region of interest; at least one raycast describing the at least one spatial region of interest; at least one spatial anchor describing the at least one spatial region of interest; at least one mesh representation describing the at least one spatial region of interest; at least one view frustum describing the at least one spatial region of interest; a difference from a previously transmitted request for spatial data of one or more spatial regions of interest; at least one semantic query describing the at least one spatial region of interest; a user pose describing the at least one spatial region of interest; a pose of the apparatus describing the at least one spatial region of interest; a pose of a real object describing the at least one spatial region of interest; or a pose of a virtual object describing the at least one spatial region of interest.

3. The apparatus of claim 1, wherein the spatial data comprises at least one of: a spatial map; an update to previously received spatial data; an extension of at least one boundary of the previously received spatial data; or additional detail for the previously received spatial data.

4. The apparatus of claim 1, wherein the request for the spatial data further comprises at least one of: a requested update frequency for the spatial data of the at least one spatial region of interest; a request for current spatial data for the at least one spatial region of interest; a request for a visible area within the at least one spatial region of interest; a request to subscribe to updates with respect to the at least one spatial region of interest; an identifier of the environment; an identifier of the request; an identifier of a coordinate system associated with the environment; at least one Level of Detail indication; or at least one depth range further defining the at least one spatial region of interest.

5. The apparatus of claim 4, wherein respective ones of the at least one depth range define one or more priorities and one or more Level of Detail indications for the spatial data for the at least one spatial region of interest.

6. The apparatus of claim 1, wherein the instructions, when executed with the at least one processor, cause the apparatus to: transmit, to the server apparatus, an indication of at least one restricted zone in the environment.

7. The apparatus of claim 1, wherein the instructions, when executed with the at least one processor, cause the apparatus to: transmit, to the server apparatus, at least one user-defined interest.

8. The apparatus of claim 1, wherein the instructions, when executed with the at least one processor, cause the apparatus to: transmit, to an application server, a request for a spatial computing channel with spatial regions of interest, wherein the request for the spatial computing channel with the spatial regions of interest comprises, at least, a requested format for the at least one spatial signal; receive, from the application server, an acceptance of the spatial computing channel with the spatial regions of interest; and establish a spatial computing service with the server apparatus using the spatial computing channel with the spatial regions of interest.

9. The apparatus of claim 1, wherein the apparatus is located in an environment that is at least partially different from the environment with which the at least one spatial region of interest is associated.

10. The apparatus of claim 1, wherein the instructions, when executed with the at least one processor, cause the apparatus to: perform rendering of virtual content in the environment based, at least partially, on the received spatial data.

11. The apparatus of claim 1, wherein the apparatus comprises at least one of: a 5G media streaming client; an augmented reality multimedia telephone service for internet protocol multimedia subsystem client; a real time communication media client; or a spatial computing client.

12. The apparatus of claim 1, wherein the server apparatus comprises at least one of: an application server; a 5G media streaming application server; an internet protocol multimedia subsystem application server; a media function; a data channel application server; a real time communication application server; an edge application server; or a spatial computing server.

13. A method comprising: transmitting, with a client apparatus to a server apparatus, a request for spatial data, wherein the request for the spatial data comprises, at least, at least one spatial signal indicating at least one spatial region of interest associated with an environment; and receiving, from the server apparatus, the spatial data for the at least one spatial region of interest.

14. An apparatus comprising: at least one processor; and at least one memory storing instructions that, when executed with the at least one processor, cause the apparatus at least to: receive, from a client apparatus, a request for spatial data, wherein the request for the spatial data comprises, at least, at least one spatial signal indicating at least one spatial region of interest associated with an environment; obtain the spatial data based, at least partially, on the request; and transmit, to the client apparatus, the spatial data.

15. The apparatus of claim 14, wherein the at least one spatial signal indicating the at least one spatial region of interest comprises at least one of: at least one bounding volume describing the at least one spatial region of interest; at least one raycast describing the at least one spatial region of interest; at least one spatial anchor describing the at least one spatial region of interest; at least one mesh representation describing the at least one spatial region of interest; at least one view frustum describing the at least one spatial region of interest; a difference from a previously transmitted request for spatial data of one or more spatial regions of interest; at least one semantic query describing the at least one spatial region of interest; a user pose describing the at least one spatial region of interest; a pose of the client apparatus describing the at least one spatial region of interest; a pose of a real object describing the at least one spatial region of interest; or a pose of a virtual object describing the at least one spatial region of interest.

16. The apparatus of claim 14, wherein the spatial data comprises at least one of: a spatial map; an update to previously received spatial data; an extension of at least one boundary of the previously received spatial data; or additional detail for the previously received spatial data.

17. The apparatus of claim 14, wherein the at least one spatial signal further comprises at least one of: a requested update frequency for the spatial data of the at least one spatial region of interest; a request for current spatial data for the at least one spatial region of interest; a request for a visible area within the at least one spatial region of interest; a request to subscribe to updates with respect to the at least one spatial region of interest; an identifier of the environment; an identifier of the request; an identifier of a coordinate system associated with the environment; at least one Level of Detail indication; or at least one depth range further defining the at least one spatial region of interest.

18. The apparatus of claim 17, wherein respective ones of the at least one depth define one or more priorities and one or more Level of Detail indications for the spatial data for the at least one spatial region of interest.

19. The apparatus of claim 14, wherein the instructions, when executed with the at least one processor, cause the apparatus to: adjust a resolution of the spatial data based, at least partially, on the request.

20. The apparatus of claim 14, wherein the apparatus comprises an application server apparatus, wherein the instructions, when executed with the at least one processor, cause the apparatus to: receive, from the client apparatus, a request for a spatial computing channel with spatial regions of interest, wherein the request for the spatial computing channel with the spatial regions of interest comprises, at least, a requested format for the at least one spatial signal; transmit, to the client apparatus, an acceptance of the spatial computing channel with the spatial regions of interest; and establish a spatial computing service with the client apparatus using the spatial computing channel with the spatial regions of interest.
